(19) United States
(12) Patent Application Publication
(10) Pub. No.: US 2016/0006476 A1
(43) Pub. Date: Jan. 7, 2016

(54) WIRELESS COMMUNICATIONS APPARATUS

(71) Applicant: SOFANT TECHNOLOGIES LTD., Edinburgh (GB)

(72) Inventors: Ahmed EL-RAYIS, Edinburgh (GB); Yan Chiew WONG, Edinburgh (GB)

(21) Appl. No.: 14/755,344

(22) Filed: Jun. 30, 2015

(30) Foreign Application Priority Data
Jul. 1, 2014 (GB) 1411710.5
Jul. 4, 2014 (GB) 1412001.8

(51) Int. Cl. H04B 1/48; H04W 4/00; H04W 8/18

(52) U.S. Cl. CPC H04B 1/48; H04W 8/18; H04W 4/005

(57) ABSTRACT

The invention provides wireless communications apparatus comprising: a wireless communications device comprising: an antenna module; circuitry in communication with the antenna module; a circuit interface within the circuitry or between the circuitry and the antenna module; and impedance matching circuitry configurable to adjust an impedance match at the circuit interface; and a controller in data communication with a memory storing a user profile associated with the wireless communications device, or with a user of the wireless communications device, the user profile comprising configuration data relating to one or more impedance matching configurations of the impedance matching circuitry, the configuration data being associated with one or more parameters of the wireless communications device, wherein the controller is configured to use configuration data from the user profile to configure the impedance matching circuitry responsive to a determination of one or more parameters of the device associated with that configuration data.

### FIELD OF THE INVENTION

The invention relates to wireless communications apparatus, methods of adjusting an impedance match at a (RF) circuit interface of a wireless communications device and a method of customising an impedance matching scheme for a wireless communications device.

### BACKGROUND TO THE INVENTION

As more and more features are incorporated into mobile wireless communications devices, it is becoming increasingly necessary to miniaturise components of such devices while maintaining or improving their performance. An important example of such a component which is being reduced in size is the antenna. However, it is difficult to maintain or improve the performance of an antenna whilst reducing its size because its performance is heavily dependent on its size (i.e. when the size of the antenna reduces, the performance typically degrades).

An exemplary antenna configuration is illustrated in FIG. 1, which shows a transceiver antenna selectively coupled to radio frequency (RF) transmitter circuitry via an amplifier and to RF receiver circuitry via a low noise amplifier.

Another factor which heavily affects antenna performance is whether there is an accurate impedance match between the antenna and its associated RF circuitry (i.e. between the antenna and the transmitter circuitry when the antenna is in transmit mode, or between the antenna and the receiver circuitry when the antenna is in receive mode).

Impedance matching is important to maximise the efficiency of power transfer in RF circuits. In order to achieve an impedance match for the transfer of maximum power from a source (e.g. RF circuitry) to a load (e.g. antenna), the complex impedance looking towards the source must be a complex conjugate impedance of the load.

The impedance match between the antenna and the RF circuitry is affected by a number of conditions, including the presence of obstacles in the immediate environment of the mobile device, such as the fingers or hand of a user, the head of a user or other objects (e.g. a table or a pocket on or in which the device may be placed). The radio frequency at which the antenna communicates can also affect the impedance match.

Both of these effects are illustrated in FIG. 2 which shows a series of plots of the distorted total field gain of an exemplary antenna versus frequency of operation of the antenna (i.e. the frequency of radio communications signals transmitted by or received from the antenna). Different plots are shown for different proximities of the antenna from the human body (+z indicates away from the human body from a reference position, −z indicates towards the human body from that reference position and d is the distance between the human body and the antenna). As shown, the gain can reduce by almost 30 dBi in the −z direction versus the +z direction at some frequencies, assuming that no action is taken to try to correct the impedance mismatch. These effects are also illustrated in FIG. 3 which shows a series of plots of return loss versus the frequency of operation of the antenna, each plot showing the effects at different distances of the antenna from the human body. A simulation of the frequency response of return loss in free space is also provided for reference. As shown in FIG. 3, the frequency response curve is shifted in the frequency domain as a result of close proximity of a human to the antenna. In addition, the return loss (e.g. at a frequency of around 9 GHz) reduces from around 26 dB to around 8 dB due to the presence of a human at 1 mm from the antenna. Again it is assumed in FIG. 3 that no action is taken to correct impedance mismatches between the antenna and its associated RF circuitry.

A significant impedance mismatch between the antenna and associated RF circuitry can thus lead to poor antenna performance. For example, an increased level of electrical power is drawn from the battery of the wireless communications device in order to account for reflections between the RF circuitry and the antenna caused by the impedance mismatch. A significant mismatch can also lead to poor transmission/reception performance which can ultimately lead to dropped calls (for example where the wireless communications device is a mobile phone).

It is also known that, by holding or wearing the wireless communications device in different ways, the impedance mismatch between the RF circuitry and the antenna module is affected differently. This is illustrated in FIG. 4 which provides plots of total radiation pattern of the antenna for six different positions of a user's fingers on the casing of a “flip” style mobile phone at two different radio frequencies. It will be understood that the plots of FIG. 4 assume that no attempt has been made to adjust the impedance matching when the user's fingers change position. That is, there is a different level of impedance mismatch between the antenna and the RF circuitry in each case caused by the change in the position of the user's fingers.

Existing tuneable impedance matching circuitry comprises an impedance mismatch sensor configured to detect an impedance mismatch and to feed back data relating to the mismatch to a controller. The controller is configured to adjust the tuneable impedance matching circuitry iteratively in response to the detected mismatch until an impedance match is obtained. However, this iterative approach incurs a lag during which antenna performance is compromised (and battery power is used up). In addition, further difficulties arise with this approach when the impedance mismatch changes over time, for example when the device is moving.

Improved adjustable impedance matching between the RF circuitry and the antenna could improve antenna performance to offset the detrimental effects of reducing antenna size. Indeed, even if the size of the antenna was not reduced, improved impedance matching between the RF circuitry and the antenna would lead to improved antenna performance and/or reduced electrical power consumption of the antenna. Accordingly there is a need for a new way of improving impedance matching in wireless communications devices which allows an impedance match to be achieved more quickly and more accurately than is possible with existing methods.

### SUMMARY OF THE INVENTION

A first aspect of the invention provides wireless communications apparatus comprising:
a wireless communications device comprising an antenna module, (RF) circuitry in communication with the antenna module, a (RF) circuit interface within the (RF) circuitry or between the (RF) circuitry and the antenna module; and impedance matching circuitry configurable to adjust an impedance match at the (RF) circuit interface; and
a controller in data communication with a memory storing a user profile associated with the wireless communications device, or with a user of the wireless communications device (typically customised in accordance with one or more usage patterns of the wireless communications device by the user), the user profile comprising configuration data relating to (e.g. for implementing) one or more (typically two or more) impedance matching configurations of the impedance matching circuitry (which are typically customised for the user associated with the user profile or a user of the device), the configuration data being associated (in the user profile) with one or more (preferably two or more) parameters of the wireless communications device,
   wherein the controller is configured to use configuration data from the user profile to configure the impedance matching circuitry responsive to a determination of one or more (or all of the) parameters of the device associated with that configuration data.

Different users interact with the wireless communications device in different ways (e.g. different users have different preferred ways of holding or wearing the device) which can (directly or indirectly) affect the impedance match at the (RF) circuit interface. The configuration data of the user profile is typically customised for the user (e.g. the user of the device or the user associated with the user profile) which allows more accurate impedance matching to be achieved when that user is using the device than compromised, universal impedance matching configurations designed for all potential users of the device.

By using configuration data from the user profile to determine the required impedance matching configuration, the impedance matching circuitry can quickly be (re)configured to improve (preferably to optimise) the impedance match at the (RF) circuit interface when one or more parameters of the device change. This is because, rather than making incremental (iterative) changes to improve the impedance match responsive to a detected impedance mismatch (which takes time), the controller is enabled to (proactively) use configuration data from the user profile to configure the impedance matching circuitry to provide an accurate impedance match much more quickly. By more quickly and more accurately achieving an impedance match at the (RF) circuit interface, signal reflections are reduced and the power efficiency of the (RF) circuitry is typically improved, which reduces power consumption (thereby increasing battery life of the wireless communications device for example) and/or improves communication performance of the wireless communications device accordingly.

The wireless communications device may comprise an RF front end comprising the said (RF) circuitry, the said antenna module and the (RF) circuit interface. The (RF) circuitry is typically analogue circuitry for propagating (and typically processing and/or conditioning) electromagnetic waves of radio frequency (e.g. electromagnetic waves of one or more frequencies within the range 3 kHz to 300 GHz, more typically electromagnetic waves of one or more frequencies within the range 400 kHz to 300 GHz). The (RF) circuitry may comprise at least any circuitry or any combination of circuitry from the following group: RF transmitter circuitry (e.g. comprising an RF modulator) operable to drive one or more transmitter/transceiver antennae to transmit radio communications signals; RF receiver circuitry (e.g. comprising an RF demodulator) operable to process radio communications signals received by one or more receiver/transceiver antennae; signal conditioning circuitry; (RF) power amplifier (which would typically be in (typically wireless) communication with the RF transmitter circuitry such as an RF modulator, and is optionally provided with a tuneable frequency response); (RF) transceiver circuitry operable to drive one or more transmitter/transceiver antennae to transmit radio communications signals and to process radio communications signals received by one or more receiver/transceiver antennae; (RF) low noise amplifier (which would typically be in communication with the (RF) receiver circuitry such as an RF demodulator, and is optionally provided with a tuneable frequency response); one or more filters; one or more phase shifters; a combiner; a coupler; a power divider; one or more switches.

Typically, the circuit interface is provided in an (RF) signal path extending through the (RF) circuitry to the antenna module. Typically the (RF) signal path is the signal path through which (RF) signals propagate between a (RF) modulator (configured to modulate a first received signal with a second (radio frequency) signal to generate a modulated (RF) signal) and the antenna module (e.g. in a transmit mode) or between the antenna module and a (RF) demodulator (e.g. a mixer, typically configured to demodulate a first received (RF) signal with a second (radio frequency) signal to generate a lower frequency demodulated signal), e.g. in a receive mode. Typically the (RF) signal path is an (RF) analogue signal path. Typically the (RF) signal path is the analogue signal path through which (RF) signals propagate between a (RF) modulator and the antenna module (e.g. in a transmit mode) or between the antenna module and a (RF) demodulator, e.g. in a receive mode.

The said impedance match at the (RF) circuit interface is typically an impedance match between a first impedance on a first side of the (RF) circuit interface and a second impedance on a second side of the (RF) circuit interface opposite the first side. The first impedance is typically an impedance of a source (typically a source of RF signal power) on the first side of the circuit interface and the second impedance is typically an impedance of a load on the second side of the circuit interface. The second (load) impedance is typically the impedance of the load on the second side of the (RF) circuit interface as viewed from the output terminals of the source on the first side of the (RF) circuit interface. It will be understood that the term “source” is not intended to be limited to an original source (such as an RF signal generator), but rather the term “source” includes an intermediate source (e.g. a circuitry stage from which (RF) signal power propagates through the interface), even if that intermediate source propagates (RF) signal power from an original source.

For example, the first impedance may comprise an output impedance of the (RF) circuitry and the second impedance may comprise an antenna module impedance (e.g. an input impedance of the antenna module or an impedance of one or more antennae of the antenna module). It may be (for example) that the first impedance comprises an output impedance of the (RF) circuitry, in which case the source comprises the said (RF) circuitry, and the second impedance comprises an input impedance of the antenna module (e.g. when the device is in a transmit mode during which it is transmitting RF waves), in which case the load comprises the antenna module, or it may be (for example) that the first impedance comprises an output impedance of the antenna module (in which case the source comprises the antenna module) and the second impedance comprises an input impedance of the (RF) circuitry (e.g. when the device is in a receive mode during which it is receiving RF waves), in which case the load comprises the RF circuitry.

In another example, the first impedance may comprise an output impedance of RF modulator circuitry and the second impedance may comprise an input impedance of a (e.g. tuneable, e.g. RF) power amplifier or filter configured to receive (or filter) signals from the RF modulator circuitry. Alternatively, the first impedance may comprise an output impedance of a (e.g. tuneable, e.g. RF) power amplifier or signal filter and the second impedance may comprise an input impedance of the antenna module, or of RF circuitry (e.g. switching circuitry or phase shifting circuitry) intermediate the power amplifier or filter and the antenna module. Alternatively, the first impedance may comprise an output impedance of a (e.g. tuneable, e.g. RF) low noise amplifier or filter and the second impedance may comprise an input impedance of RF demodulator circuitry configured to demodulate signals from the low noise amplifier or signal filter. Alternatively, the first impedance may comprise an output impedance of the antenna module (or of RF circuitry intermediate the antenna module and the low noise amplifier) and the second impedance may comprise an input impedance of a (e.g. tuneable, e.g. RF) low noise amplifier or filter in communication with the antenna module. One of the first and second impedances may comprise the impedance of a transmission line extending between two RF circuitry stages or between the RF circuitry and the antenna module.

Nevertheless, it will be understood that the circuit interface may be provided anywhere within the (RF) circuitry or between the circuitry and the antenna module. Accordingly, the first and second impedances may comprise any other impedances within the circuitry (typically along the (RF) signal path) or between the circuitry and the antenna module.

The impedance matching circuitry may be provided at the (RF) circuit interface. The impedance matching circuitry may be provided between the first and second sides of the (RF) circuit interface.

The first and/or second impedances may be frequency dependent. For example, it may be that the first and/or second impedances have reactive components whose impedance is dependent on the frequency of signals being transmitted or received by the antenna module.

The first and/or second impedances may be tuneable. For example, a power amplifier may be provided with a tuneable frequency response by way of one or more reactive components having tuneable impedances or any other tunable technique. In the example where the circuit interface is between RF modulator circuitry and a power amplifier, the first impedance comprising an output impedance of the RF modulator circuitry and the second impedance comprising an input impedance of the power amplifier, it may be that the input impedance of the power amplifier changes when its frequency response is tuned to account for a change in transmission frequency of signals being transmitted by the antenna module (and therefore the modulation frequency of the RF modulator). Accordingly, there is a need for impedance matching at such an interface.

It will be understood that by the impedance of an antenna, we mean the impedance of the antenna as seen by the circuitry or by a transmission line extending between the circuitry and the antenna module (which may include the effects of a user touching (or in close proximity with) an external surface of the antenna and/or the effects of a user (or other object(s) or the user's environment) interacting with a near-field of the antenna).

It may be that the circuit interface is provided between the circuitry and the antenna module. It may be that the circuit interface connects the circuitry to the antenna module. It may be that there is no additional circuitry between the said circuitry and the antenna module.

Effects on the impedance match at the circuit interface can be direct or indirect. For example, it may be that the interface is between the circuitry and the antenna module, in which case any (e.g. physical) interaction between the user and an antenna of the antenna module may cause a change in the antenna impedance as seen by the circuitry. In this case, the effect of the interaction between the user and the antenna has a direct effect on the impedance match at the interface. In another example, the interface may be provided between RF modulator circuitry and a power amplifier. In this case, it may be that an interaction between the user and an antenna of the antenna module causes a change in the impedance of the antenna module as seen by the power amplifier (or by other circuitry between the power amplifier and the antenna module). If the impedance match between the power amplifier and the antenna module (or between the other circuitry between the power amplifier and the antenna module) is not corrected, the transfer of signal power between the power amplifier and the antenna will be less efficient. In this case, additional signal power needs to be generated by the power amplifier to take into account the reduced efficiency of the power transfer. By changing the signal power required to be generated by the power amplifier, the input impedance of the power amplifier may change, leading to an impedance mismatch at the circuit interface. Thus, the interaction between the user and the antenna in this case would indirectly affect the impedance match at the interface.

Typically, the wireless communications device is a handheld or wearable wireless communications device, mobile wireless communications device, mobile phone, mobile smartphone, phablet, tablet, laptop or netbook computer, picocell, femtocell, base station, smart watch, wearable sensors, signal node, beacon, router or repeater.

The antenna module typically comprises one or more antennae. The antennae of the antenna module may comprise one or more transmitter antennae (e.g. operable to transmit radio communications signals such as 2G, 2.5G, 3G, 4G mobile telecommunications signals, Bluetooth signals, Wi-Fi signals or Wi-Max signals) and/or one or more receiver antennae (e.g. operable to receive radio communications signals such as 2G, 2.5G, 3G, 4G mobile telecommunications signals, Bluetooth signals, Wi-Fi signals or Wi-Max signals) and/or one or more transceiver antennae (e.g. operable to transmit and receive radio communications signals such as 2G, 2.5G, 3G, 4G mobile telecommunications signals, Bluetooth signals, Wi-Fi signals or Wi-Max signals).

The impedance matching circuitry may comprise circuitry configurable to select one or more antennae from a group of antennae (the group comprising a plurality of antennae). It may be that two or more antennae in the said group of antennae (or different selectable combinations of antennae in the said group of antenna) have different impedances.

Typically the impedance matching circuitry comprises tuneable impedance matching circuitry.

The (typically tuneable) impedance matching circuitry may be provided at the circuit interface. As indicated above, it may be that the impedance match is provided between a first impedance on a first side of the circuit interface and a second impedance on a second side of the circuit interface opposite the first side. In this case, the first impedance may be in communication with the second impedance through (by way of) the impedance matching circuitry. For example, where the interface is provided between the circuitry and the antenna module, the (RF) circuitry is typically in communication with the antenna module through (by way of) the (tuneable) impedance matching circuitry.

The tuneable impedance matching circuitry typically comprises an adjustable impedance. The adjustable impedance typically comprises an adjustable reactance. It may be that the tuneable impedance matching circuitry comprises two or more impedance matching networks, and the controller may be configurable to select one of the said impedance matching networks from the said two or more impedance matching networks to thereby connect the first impedance on the first side of the circuit interface to the second impedance on the second side of the circuit interface by way of the selected impedance matching network.

The tuneable impedance matching circuitry preferably comprises one or more components having a tuneable impedance. Typically one or more of the one or more components having a tuneable impedance have a tuneable reactance. The controller is typically configurable to tune the impedance (typically including the reactance) of one or more such components to thereby adjust the impedance match at the circuit interface.

The impedance matching circuitry may comprise one or more (active or reactive) components or one or more groups of components having an impedance (reactance) which can be current or voltage controlled. For example, the impedance matching circuitry may comprise a bank of switched (e.g. MEMS) capacitors having an impedance which can be current or voltage controlled (e.g. by opening or closing capacitor switches to activate or deactivate capacitors within the bank). Additionally or alternatively, the impedance matching circuitry may comprise one or more tuneable inductances, capacitances or couplings capable of compensating an impedance mismatch at the circuit interface. The tuneable components may comprise, for example, semiconductor varactors, micro-electro-mechanical systems (MEMS) varactors, MEMS switched capacitors, ferroelectric capacitors, a bank of switched capacitors (e.g. a bank of switched MEMS capacitors), P-I-N diode or any other component capable of implementing an impedance (reactance) which is variable responsive to a control signal.

Preferably, the tuneable impedance matching circuitry (where provided) comprises a tuneable capacitor. The tuneable capacitor is preferably a MEMS capacitor. The tuneable capacitor typically has an impedance (capacitance) which is variable responsive to a control signal. In the case where the impedance matching circuitry comprises a bank of MEMS capacitors, it may be that one or more (or all) of the MEMS capacitors of the bank have respective capacitances which are voltage and/or current controlled (preferably having a linear response).

The one or more components having a tuneable impedance preferably comprise a component (e.g. tuneable MEMS capacitor) having an impedance (e.g. a reactance such as a capacitance) which varies continuously responsive to a varying control signal (along at least part of, preferably substantially all of, its impedance tuning range).

The one or more components having a tuneable impedance typically comprise a component having a reactance (e.g. capacitance) which varies linearly (or substantially linearly) responsive to a (dynamically, simultaneously) varying (e.g. current or voltage) control signal.

A linear tuning response is preferred as it avoids abrupt changes in impedance which could result in a high reflected power at the circuit interface. In addition, a linear tuning response helps to minimise interference/harmonic noise which improves the accuracy of the impedance matching that can be achieved by the impedance matching circuitry.

It will be understood that the control signal may comprise a voltage control signal and/or an electrical current control signal.

The configuration data may comprise one or more functions which vary in dependence on one or more (e.g. of the said or all of the said) parameters associated with that configuration data (thus the configuration data may be associated with the said parameters by way of one or more functions which vary in dependence on said parameters). In this case, the said parameters of the device associated with the configuration data may be one or more variables of the said function(s). Thus, the same configuration data may be used to implement different impedance matching configurations on the impedance matching circuitry as different determined parameters used in the same function(s) result in different configurations of the impedance matching circuitry.

One of the parameters of the device associated with the said configuration data is typically a (radio) frequency (mode/band/channel) at which the wireless communications device is configured to transmit and/or receive (radio) communications signals. One of the determined parameters associated with the (selected) configuration data is typically the (radio) frequency (mode/band/channel) at which the wireless communications device is configured to transmit and/or receive (radio) communications signals.

The controller is typically configured to use configuration data from the user profile to configure the impedance matching circuitry responsive to a determination of a frequency (e.g. mode/band/channel) at which the antenna module is transmitting and/or receiving radio frequency signals.

The wireless communications device typically comprises baseband circuitry configured to manage one or more radio functions of (e.g. radio frequency transmissions from and/or radio frequency reception by) the wireless communications device. Typically the baseband circuitry is provided in data communication with the controller. The baseband circuitry is typically configured to provide (radio) frequency data to the controller indicative of a (radio) frequency (mode/band/channel) at which the wireless communications device is configured to transmit or receive (radio) communication signals.

Typically the controller is configured to use configuration data from the user profile to change the configuration of the impedance matching circuitry responsive to a determination of a change in one or more parameters of the device associated with that configuration data.

The configuration data may comprise two or more (different) configuration data sets, each of the configuration data sets relating to (typically specifying) a (different) respective impedance matching configuration of the impedance matching circuitry.

It will be understood that by “configuration data set”, we mean configuration data that is capable of being used to configure the impedance matching circuitry in accordance with a particular configuration. A configuration data set may comprise, for example, one or more control signal values for tuning the impedance of one or more components (of the impedance matching circuitry) having a tuneable impedance, one or more impedance values to be applied to such components, an identifier for selecting an impedance matching network from a plurality of impedance matching networks of the impedance matching circuitry, an antenna length of an antenna having a variable length or any other suitable configuration data.

The said parameters of the device associated with the configuration data may be associated with the configuration data by way of one or more conditions. It may be that the controller is configured to use (e.g. selected) configuration data from the user profile to configure the impedance matching circuitry responsive to a determination that one or more (or all of) said one or more conditions associated with that configuration data are or will be met. It will be understood that the determination of whether the said conditions are met is typically performed taking into account the said determined one or more parameters.

The one or more conditions may specify (for example) that one or more parameters have specified parameter values or parameter values within a specified range of values.

Each of the configuration data sets of the configuration data is typically associated with one or more (different) respective (said) conditions (and/or with (different) respective combinations of (said) conditions).

It may be that the controller is configured to use a selected one of the configuration data sets to configure the impedance matching circuitry responsive to a determination that one or more (or all) of the conditions associated with that configuration data are or will be met.

Preferably the (or each of one or more sets, or each set, of) configuration data is associated with two or more conditions.

The controller is typically configured to use selected configuration data (e.g. a selected configuration data set) from the user profile to configure the impedance matching circuitry responsive to a determination that two or more (or all of the) conditions associated with that configuration data are or will be met.

In some embodiments, the said conditions associated with the configuration data may comprise conditions associated with the wireless communications device. Typically the controller is configured to use selected configuration data from the user profile to configure the impedance matching circuitry responsive to a determination that one or more (or two or more) conditions associated with the wireless communications device (and the said customised impedance matching configuration) are or will be met.

The location at which the wireless communications device transmits and/or receives radio communication signals can affect the frequency (e.g. frequency channel or frequency standard or frequency mode) at which the wireless communications device transmits and/or receives radio communication signals. As antenna impedance and the impedances of reactive components in the circuitry are typically frequency dependent, the location of the device can therefore affect the antenna impedance and the impedances of reactive components in the circuitry. Thus the impedance match at the circuit interface is typically affected by the frequency at which the wireless communications device communicates. The local environment in which the device is located can also affect the antenna impedance.

The location at which the wireless communications device transmits and/or receives radio communication signals can also affect RF signal performance.

For example, the location of the wireless communications device can additionally or alternatively affect the distance between the wireless communications device and one or more base stations (or access points, or cell, or micro cell, or nano cell, or repeater) with which it communicates and/or through which the wireless communications device sends and receives communications signals. This in turn affects the signal power required to be transmitted from and/or signal power received at the wireless communications device, which may affect an (e.g. input or output) impedance of the circuitry.

The location of the wireless communications device can additionally or alternatively affect the direction from the wireless communications device of one or more base stations with which the wireless communications device communicates (and/or through which the wireless device sends and receives communications signals). This can also affect the signal power required to be transmitted from and/or signal power received at the wireless communications device, which can affect an (e.g. input or output) impedance of the circuitry.

The location of the wireless communications device can additionally or alternatively affect the signal propagation path (and therefore the signal attenuation and signal reflections incurred over the signal propagation path) taken by signals sent between the wireless communications device and one or more base stations within which it communicates. This can also affect the signal power required to be transmitted from and/or signal power received at the wireless communications device, which can affect an (e.g. input or output) impedance of the circuitry.

Improved impedance matching can thus be achieved by using configuration data from the user profile relating to a determined location of the device.

One of the parameters of the device associated with the said configuration data is typically a position of the device or a locus in which the device is located. One of the determined parameters associated with the (selected) configuration data is typically the position of the device or a locus in which the device is located.

The conditions associated with the (e.g. with each of one or more sets of, or each set of) configuration data of the user profile may comprise a location condition relating to a (current or future) position of the wireless communications device.

A location condition may specify (for example) that the wireless communications device occupies a particular position or locus (or, for example, that the device is approaching a particular position or locus). In this case, the configuration data associated with the said location condition typically allows an accurate impedance match to be achieved at the circuit interface at that position or locus (at least when the wireless communications device is being used by the said user). The controller may be configured to use selected configuration data (e.g. a configuration data set selected from a plurality of configuration sets) associated with the said location condition from the user profile to configure the impedance matching circuitry responsive to a determination that the said location condition is or will be met.

The controller may be configured to estimate a position of the device using data (e.g. data identifying local base stations and/or their positions) from the baseband circuitry. Additionally or alternatively the wireless communications apparatus (e.g. the wireless communications device and/or a server in data communication with the wireless communications device) may comprise a positioning module (e.g. a GPS module, or other (e.g. wireless or software based or hybrid) positioning module) configured to estimate the position of the wireless communications device and in data communication with the controller. In this case, the controller may determine an estimated position of the device from the positioning module.

Where the configuration data comprises a plurality of configuration data sets, two or more (or each of the) configuration data sets are typically associated with different location conditions.

The conditions associated with configuration data may comprise one or more time conditions relating to one or more times or time periods (e.g. time of day or day of the week). For example, a time condition may specify one or more times of day (on every day or on specific days) at which the configuration data associated with that condition may be used to configure the impedance matching circuitry. The controller may be configured to use selected configuration data from the user profile to configure the impedance matching circuitry responsive to a determination that a time condition associated with that configuration data is or will be met.

The conditions associated with the configuration data of the user profile may comprise a (radio) frequency condition relating to a (radio) frequency (or frequency channel or band, or frequency standard or frequency mode) at which the wireless communications device is configured to transmit and/or receive (radio) communication signals.

The frequency condition may specify that the wireless communications device is communicating on a particular frequency (or frequency channel or band, or frequency standard or frequency mode). In this case the controller may be configured to use selected configuration data (e.g. a selected configuration data set from a plurality of configuration data sets) from the user profile responsive to a determination that the frequency condition associated with that configuration data is or will be met.

As discussed above, the controller may be configured to determine the frequency (or frequency channel or band, or frequency standard or frequency mode) at which the device is transmitting and/or receiving (radio) communications signals from frequency data provided by (or obtained from) the baseband circuitry.

It may be that the wireless communications device comprises one or more sensors in data communication with the controller. For example it may be that the wireless communications device comprises any one or more of the sensors of the following group of sensors: a proximity sensor configured to determine whether there are any external objects close to the wireless communications device; a voice sensor (e.g. microphone) configured to determine whether a user is speaking into the wireless communications device; a screen sensor configured to determine whether a screen of the wireless communications device is on or off; an accelerometer configured to detect movement of the device; a headphones sensor configured to determine whether headphones are connected to the wireless communications device; a call mode sensor configured to determine whether a telephone call is in progress on the wireless communications device; an ambient light sensor (which may be configured to be on when the device is active and off when the device is idle); a compass configured to determine an orientation of the device; temperature and/or pressure and/or touch sensors configured to determine one or more characteristics relating to the way in which the user is holding or wearing the wireless communications device. The sensors may be implemented in software (e.g. a call mode sensor may be a signal from an operating system running on the wireless communications device indicating whether the wireless communications device is being used to make a call), in hardware (e.g. a pressure sensor may be provided as part of the wireless communications device) or in a combination of hardware and software (e.g. a headphones sensor may comprise an audio jack of the wireless communications device and software which determines from the audio jack whether or not headphones are connected to the wireless communications device).

One of the parameters of the device associated with the said configuration data is typically a sensor parameter relating to one or more sensors of the wireless communications device. One of the determined parameters associated with the (selected) configuration data is typically a (or the) sensor parameter relating to one or more sensors of the wireless communications device.

The conditions associated with the configuration data of the user profile may comprise one or more sensor conditions relating to signals received by the controller from the said one or more sensors of the wireless communications device (or data derived from signals from the said one or more sensors).

It may be that the controller is configured to use selected configuration data (e.g. a selected configuration data set from a plurality of configuration data sets) from the user profile responsive to a determination that the sensor condition(s) associated with that configuration data are or will be met.

For example, a sensor condition may comprise a condition which specifies that a proximity sensor detects an object in close proximity thereto. The proximity of the device to a user's body affects the impedance of the antenna module, and this can affect the impedance match at the circuit interface directly (e.g. where the interface is between the circuitry and the antenna module) or indirectly (e.g. where the circuit interface is within the circuitry and the change in impedance of the antenna module causes additional signal reflections, requiring increased transmitted signal power, which in turn affects an impedance of the circuitry). This proximity information can thus be used by the controller to select the most appropriate configuration data set from the user profile (i.e. a configuration data set associated with that condition is selected responsive to a determination that the condition is or will be met).

In another example, a sensor condition may comprise a condition which specifies that headphones are connected to the wireless communications device. If headphones are connected to the device, it may be an indication that the wireless communications device is not proximate the user's head. Additionally or alternatively, if headphones are connected to the device, it may be an indication that the user will hold or wear the device in a particular way, or that the device is being stored in a user's pocket. This information can be used by the controller to select the most appropriate configuration data set from the user profile (i.e. a configuration data set associated with that sensor condition is selected responsive to a determination that the sensor condition is or will be met).

Preferably, the conditions associated with the configuration data (e.g. with each of one or more, or two or more, configuration data sets, or each configuration data set) comprise sensor conditions relating to signals from two or more of the sensors of the wireless communications device (or data derived from signals from two or more of the sensors of the wireless communications device).

The controller may be configured to use selected configuration data (e.g. a configuration data set selected from a plurality of configuration data sets) from the user profile to configure the impedance matching circuitry responsive to a determination that two or more sensor conditions associated with that configuration data are or will be met.

It may be that two or more sensor conditions associated with the configuration data (or with one or more, or each of two or more, configuration data sets) each relate to different types of sensors.

The two or more sensor conditions may comprise (for example) a proximity sensor condition and a call sensor condition (such as a voice or a screen sensor condition). For example, as discussed, signals from a proximity sensor can be used to determine whether the wireless communications device is close to the user's body. Signals from one or more other sensors can be used to determine which part of the user's body the wireless communications device is near, to thus enable the selection of configuration data relating to a more accurate impedance matching configuration. For example, signals from a voice sensor indicating that the user is speaking into the wireless communications device may be an indication that the user is making a call, thereby providing an indication that the wireless communications device is near the hand and head of the user. The fact that the device is being used to make a call can be taken into account by the configuration data associated with the proximity and call sensor conditions to optimise the impedance match at the circuit interface.

As discussed above, the way in which a user holds or wears the wireless communication device can have a significant effect on an impedance of the antenna module, and therefore on the impedance match (directly or indirectly) at the circuit interface. The wireless communications device may comprise touch and/or pressure and/or temperature sensors configured to determine one or more characteristics relating to how the user is holding or wearing the wireless communications device. For example, the sensors may be configured to determine a position of the user's fingers on the device. In another example the sensors may be configured to determine a proportion (e.g. surface area, fraction of a total surface area) of one or more antennae of the antenna module which is/are covered (e.g. by the user's hand) in use.

The conditions associated with configuration data of the user profile may comprise a sensor condition relating to one or more characteristics relating to (e.g. defining) how the user holds or wears the wireless communications device.

For example, the said sensor condition may specify that a portion of the surface area of one or more antennae of the antenna module (or of one or more antennae of the antenna module in use) covered (e.g. by a user's hand) in use comprises a particular value or lies in a particular range of values. In another example, the said sensor condition may specify that the user's fingers in contact with the device adopt a specific configuration.

The controller may be configured to use selected configuration data (e.g. a configuration data set selected from a plurality of configuration sets) from the user profile to configure the impedance matching circuitry responsive to a determination that a or the said sensor condition(s) associated with that configuration data relating to one or more characteristics defining how the user is holding or wearing the wireless communications device are or will be met.

The controller may be configured to determine whether a or the said sensor condition(s) associated with that configuration are met from signals received from one or more pressure and/or temperature and/or touch sensors of the wireless communications device (or data derived therefrom). The controller may be configured to predict whether a sensor condition will be met using signals received from one or more other sensors (e.g. which may indicate that the user is making a call, and is therefore expected to hold or wear the device in a particular way). It may be that the controller thus predicts one or more actions or behaviour of the user, and uses selected configuration data from the user profile to configure the impedance matching circuitry responsive to said prediction.

Additionally or alternatively, the configuration data (e.g. each of one or more corresponding configuration data sets of the user profile) may take into account one or more ways of holding or wearing the wireless communications device which is typically (e.g. most frequently) adopted by the user. The said one or more ways of holding or wearing the wireless communications device may (each) be specific to a particular action being performed (or predicted to be performed) by the user, such as making a call, browsing the internet or watching video.

As indicated above, it may be that the wireless communications device comprises a motion sensor (e.g. accelerometer and/or gyroscope) configured to detect movement of the device. The motion sensor and/or the controller may be configured to determine a speed and/or direction of movement of the device. It may be that the one or more conditions associated with the configuration data comprise motion conditions relating to a speed of movement of the device and/or relating to a direction of movement of the device. For example, the controller may be configured to determine whether the speed of movement of the device exceeds a threshold and, if the speed of movement of the device exceeds a threshold, the controller may be configured to update the configuration of the impedance matching circuitry more frequently to account for faster changes in the impedance match caused by the speed of movement of the device (e.g. quicker changes in local environment, quicker changes in transmitter/receiver frequency as more likely to change the base station through which it sends and receives communications signals more quickly). In another example, the speed of movement of the device may indicate that the user is holding or wearing the wireless communications device in a particular way (e.g. the wireless communications device may be strapped to the user's arm when the user is running) or that the user is travelling in a vehicle (e.g. a car or a train). The speed of movement of the device may additionally or alternatively indicate a typical posture of the user or that the device is stored in a device case and/or in a user's pocket. Typically the controller is configured to use selected configuration data from the user profile to configure the impedance matching circuitry responsive to a determination that one or more motion conditions are (or will be) met.

It will be understood that motion of the wireless communications device may alternatively be determined from one or more positioning modules. For example, motion of the wireless communications device may be determined from a GPS positioning module, a software based positioning module, or a positioning module which determines the position of the device from the relative positions of a plurality of wireless beacons (e.g. Bluetooth beacons or wireless access points such as Wi-Fi access points). At least part of the said one or more positioning modules are typically provided on the device. Additionally or alternatively, motion of the wireless communications device may alternatively be determined from a (e.g. third party) location information service.

It may be that the one or more conditions associated with the configuration data comprise a gender condition relating to the gender of the user of the device. In general terms, males and females have different palm and finger sizes, and they tend to hold or wear wireless communications devices in different ways. Accordingly, again in general terms, it may be that the gender of the user affects the impedance match. In such cases, it can be beneficial for the controller to select gender specific configuration data from the user profile which it uses to configure the impedance matching circuitry.

It may be that the user profile is generated from a generic profile which is customised over time in accordance with the user's actions or behaviour. In this case, typically the controller is configured to use a determined gender of a user (as an initial guide) to select the most appropriate configuration data from a generic user profile. It may be that the generic user profile contains generic male user profile data and generic female user profile data and the controller is configured to select generic male user profile data responsive to a determination that the user is male and/or to select generic female generic user profile data responsive to a determination that the user is female. The gender of a user may be determined from a manual input by the user, from a pre-existing user profile, or it may be derived from the way in which the user interacts with the device (e.g. the size of the user's palm and/or fingers, or the way in which the user holds or wears the device).

It may be that the controller is configured to obtain (e.g. updated) location information relating to the position of the wireless communications device, e.g. responsive to one or more signals (e.g. from one or more sensors, such as motion sensors (accelerometer), or positioning modules, or data derived therefrom) indicating movement of the device.

One of the parameters of the device associated with the said configuration data may be an orientation parameter of the device. One of the determined parameters associated with the (selected) configuration data may comprise the orientation of the device.

As indicated above, it may be that the wireless communications device comprises an orientation sensor (e.g. compass or gyroscope) configured to determine an orientation of the wireless communications device. The said orientation sensor is typically provided in data communication with the controller. The conditions associated with configuration data in the user profile may comprise one or more orientation conditions relating to the orientation of the device. For example, an orientation condition may specify that the wireless communications device is in a landscape or portrait orientation (or between a landscape and a portrait orientation). It may be that the controller is configured to use selected configuration data from the user profile to configure the impedance matching circuitry responsive to a determination that an orientation condition associated with that configuration data is or will be met.

One of the parameters of the device associated with the said configuration data may be a hardware parameter relating to the hardware configuration (or hardware design) of the wireless communications device. One of the determined parameters associated with the (selected) configuration data may be a (or the) hardware parameter relating to the hardware configuration of the device.

The conditions associated with the configuration data of the user profile may comprise one or more hardware conditions relating to a hardware design or hardware configuration (e.g. make, model, style, form-factor, functionality, types of sensor modules provided) of the wireless communications device.

For example, the wireless communications device may have a first hardware portion moveable relative to a second hardware portion (e.g. a “flip” style mobile smartphone or a smartphone with a slidable keypad). A hardware condition specify a position of the first hardware portion relative to the second hardware portion (e.g. keypad fully extended or retracted, “flip” style phone open or closed). It may be that the controller is configured to determine whether one or more hardware conditions are or will be met responsive to signals from one or more sensors of the wireless communications device (e.g. a sensor configured to determine the position of the first hardware portion relative to the second hardware portion).

The controller may be configured to use selected configuration data from the user profile to configure the impedance matching circuitry responsive to a determination that one or more hardware conditions associated with that configuration data are or will be met.

The (or one or more sets, or each set, of) configuration data of the user profile is typically (at least partly) derived from (e.g. one or more patterns of) usage of the device by the user (e.g. by using the method according to the fourth aspect of the invention—see below).

The configuration data associated with one or more impedance matching configurations (or one or more or all of the configuration data sets) preferably takes into account a hardware design (e.g. make, model, form factor, style, device performance/specification, antenna characteristics/performance, signal noise level etc.) of the wireless communications device.

Preferably the controller is configured to predict one or more actions or behaviour of the user and to use (e.g. selected) configuration data from the user profile to configure the impedance matching circuitry responsive to the said prediction of actions or behaviour of the user. This helps to prevent large or abrupt impedance mismatches from occurring.

The controller preferably comprises one or more predefined modes in which it is configured to predict a change in one or more parameters of the device (e.g. communications frequency of the wireless communications device, one or more characteristics defining how the user is holding or wearing the device, location of the device, orientation of the device etc).

(For example in a said predefined mode) it may be that the said determination of one or more parameters of the device comprises a prediction of one or more parameters of the device (e.g. a predicted location, frequency of operation, sensor value and so on).

Preferably in the said predefined mode(s) the controller is configured to predict a change in one or more parameters of the device affecting the impedance match (directly or indirectly) at the circuit interface.

The user profile may comprise data associated with (e.g. defining) the said one or more predefined modes of the controller.

The controller may be configured to predict a change in the said one or more parameters in a said predefined mode based (at least partly) on data associated with that predefined mode from the user profile (and typically based on the said determination of one or more parameters of the device). The controller may be configured to predict a change in the said one or more parameters in a said predefined mode based (at least partly) on a detected position (or two or more, e.g. subsequent or consecutive, detected positions) of the wireless communications device.

The controller may thus be configured to predict a change in one or more parameters of the device (e.g. one or more of the above parameters) which affect an impedance match at the circuit interface using data associated with the predefined mode in the user profile.

The controller may be configured to use configuration data from the user profile to reconfigure the impedance matching circuitry responsive to the said prediction of a parameter change. This helps to prevent large or abrupt impedance mismatches from occurring.

The controller may be configured, in a said predefined mode, to determine that one or more (or two or more or all of the) conditions associated with configuration data in the user profile are or will be met based on one or more predictions made by the controller. The controller may be configured, in a said predefined mode, to use selected configuration data from the user profile to configure the impedance matching circuitry responsive to a prediction that one or more (or two or more or all of the) conditions associated with that configuration data are or will be met (typically based at least partly on the said determined parameters of the device).

The data in the user profile associated with one or more of the said predefined modes of the controller may comprises a location track relating to a pattern of movement of the user (typically a pattern of movement of the user when the user was holding or wearing the wireless communications device).

For example, the location track may relate to a journey traveled previously by the user (typically when the user was holding or wearing the wireless communications device) at least once, preferably more than once (e.g. two or more times, or three or more times). The location track may therefore include, or be related to, two or more subsequent or consecutive positions or loci which can be expected to be occupied by the wireless communications device in the predefined mode with which the location track is associated. Each of the said positions or loci may be associated with a different customised impedance matching configuration of the impedance matching circuitry. The data in the user profile associated with a predefined mode may comprise configuration data which can be used by the controller to implement the said different customised impedance matching configurations of the impedance matching circuitry.

It may be that two or more configuration data sets are associated with one of the said predefined modes in the user profile. In this case, one or more (or each) of the said two or more configuration data sets (or each of the said two or more configuration sets other than a first one of the said two or more configuration data sets) are typically each associated with one or more respective secondary conditions. The controller may be configured to use a selected one of the configuration data sets to configure the impedance matching circuitry when it is configured in the said predefined mode responsive to a determination that the said secondary condition(s) associated with that configuration data set are or will be met. The secondary conditions may comprise any one or combination of the conditions discussed above.

For example, the said secondary conditions may include a secondary location condition relating to a particular position or locus on a location track. The controller may be configured to use a first selected configuration data set from the user profile to configure the impedance matching circuitry responsive to a determination that the wireless communications device occupies (or will occupy) a first position or locus on the track and to use a second selected configuration data set from the user profile to configure the impedance matching circuitry responsive to a determination that the wireless communications device occupies (or will occupy) a second position or locus on the track different from the first position or locus. Additionally or alternatively, the said secondary conditions may include one or more time conditions specifying one or more times or time periods (e.g. time of day or day of the week). In one embodiment, the controller (when in the said predefined mode) may be configured to use a first selected configuration data set from the user profile to configure the impedance matching circuitry responsive to a determination that the wireless communications device is on (or adjacent to) the track (or at a particular position or locus on the track) and to use a second selected configuration data set from the user profile to configure the impedance matching circuitry a predetermined period of time after the use of the first selected configuration data set. In another embodiment, the controller (when in the said predefined mode) may be configured to use a first selected configuration data set from the user profile to configure the impedance matching circuitry responsive to a determination that the wireless communications device is on (or adjacent to) the track and to use a second selected configuration data set from the user profile to configure the impedance matching circuitry responsive to a determination that the device has moved and/or responsive to a direction of movement of the device.

The controller may be configured to enter one of the said predefined modes responsive to a determination that one or more conditions associated with that predefined mode are or will be met.

The said conditions may comprise any of the conditions set out above in relation to the configuration data. However, most typically in the case of location tracks, the said one or more conditions comprise one or more location conditions relating to a (current or future) position of the device (e.g. that the device is at a position or locus, or has occupied two or more subsequent or consecutive positions or locus, on or adjacent to the track). One or more of the said conditions may comprise a location condition relating to a current position of the device and a direction of travel of the device (which direction of travel may be determined, for example, from signals received from a positioning module or compass or data derived therefrom).

Once configured in a said predefined mode, the controller may be configured to remain in that predefined mode for a predetermined period of time. Additionally or alternatively, the controller may be configured to remain in that predefined mode until it is determined (e.g. by the controller) that one or more of the said conditions associated with the said predefined mode are not met (and/or one or more exit conditions are met). For example, the controller may be configured to remain in a predefined mode associated with a location track until it is determined that the wireless communications device is not at a position or locus on or adjacent to the track.

It may be that the controller is configured to (repeatedly, e.g. periodically) check whether conditions associated with the predefined mode are met. The controller may be configured such that, when the controller is configured in a predefined mode, secondary conditions are checked more frequently (at least for a period of time or until an event occurs) than conditions associated with the said predefined mode.

The frequency (e.g. regularity) with which the controller checks whether conditions associated with the predefined mode are met may increase or decrease responsive to one or more parameters (or to the determination of one or more parameters). For example, the frequency (e.g. regularity) with which the controller checks whether conditions associated with the predefined mode are met may increase or decrease responsive to a determined position of the device and/or responsive to a determination that the device is moving and/or responsive to a direction of movement of the device and/or responsive to a time (e.g. a time of day or day of the week).

For example, the controller may be configured to increase the frequency (e.g. regularity) with which it checks whether the wireless communication device occupies a position or locus on a location track responsive to a determination that the wireless communication device is at a position near a location track or approaching a location track at a time associated with a pattern of movement of the device with which the location track is associated.

It may be that, when configured in a said predefined mode, the controller is configured to use first selected configuration data from the user profile to configure the impedance matching circuitry responsive to a predicted change in one or more parameters affecting the impedance match at the circuit interface and to use second selected configuration data from the user profile to configure the impedance matching circuitry responsive to confirmation that the predicted parameter change has occurred (e.g. when the said predicted change would cause one or more conditions associated with that second configuration to be met).

Typically the second selected configuration data provides a more accurate impedance match in the event that the predicted parameter change occurs than the first selected configuration data. Typically the first selected configuration data provides a more accurate impedance match in the event that the said parameter remains constant (as opposed to changing as predicted) than the second selected configuration data. Typically the first selected configuration data provides a more accurate impedance match in the event that the predicted parameter change occurs than the impedance matching configuration of the impedance matching circuitry immediately prior to the configuration of the impedance matching circuitry derived from the first selected configuration data.

The wireless communications apparatus may further comprise an impedance mismatch sensor configured to detect an impedance mismatch at the circuit interface.

The impedance mismatch sensor may for example comprise one or more of the following: RF voltage detector (such as a diode detector, temperature compensated diode detector, logarithmic amplifier or any other means to detect an RF voltage magnitude), phase detector (such as one or more variable capacitor or any other means to detect an RF phase magnitude) or power detector (such as one or more directional coupler or any other means to detect an RF power).

It may be that the controller is configured to use selected configuration data from the user profile to configure the impedance matching circuitry responsive to a detection of an impedance mismatch at the circuit interface by the impedance mismatch sensor.

The controller preferably comprises a learning mode in which it is configured to determine refined or new customised impedance matching configurations for achieving an impedance match at the circuit interface (e.g. after the impedance matching circuitry has been configured using data from the user profile).

The controller is also typically configured to store determined new or customised impedance matching configurations in the user profile in the said learning mode.

The wireless communications device preferably comprises a feedback loop which extends from the interface to the controller by way of the impedance mismatch sensor.

It may be that, in the learning mode, the controller is configured to adjust the impedance matching configuration of the impedance matching circuitry responsive to a detected impedance mismatch by the impedance mismatch sensor.

The impedance matching configuration is typically adjusted until an impedance match is detected by the impedance mismatch sensor (or an impedance mismatch is no longer detected by the impedance mismatch sensor). The controller is typically configured to store configuration data relating to the impedance matching configuration which provides the impedance match (e.g. data from which the impedance matching configuration can be derived) in the user profile. The controller is also typically configured to store one or more parameters of the wireless communications device and/or one or more conditions in the user profile which may be associated with the said configuration data in the user profile. The parameters may comprise any one or combination of the parameters discussed above (or indeed any other suitable parameters). The conditions may comprise any one or combination of the conditions described above (or indeed any other suitable conditions).

It may be that, in the learning mode, the controller is configured to receive signals from one or more pressure and/or touch and/or temperature sensors of the wireless communications device and to determine or update one or more characteristics stored in the user profile relating to a way of holding or wearing the wireless communications device which is preferred by the user. For example, the determined characteristics may relate to a way of holding or wearing the wireless communications device which is adopted most often by the user (or which is adopted most often by the user when the device is being used for a particular action, such as making a call, watching video, browsing the internet, interacting with the screen etc). It may be that the controller is further configured to determine or update configuration data of the user profile responsive to the determination of a change in one or more characteristics relating to the said way of holding or wearing the wireless communications device which is preferred (or most often adopted) by the user. Thus, the user profile can be updated dynamically in response to a change in behaviour by the user.

It may be that the user profile initially comprises default configuration data relating to one or more default impedance matching configurations. The default configuration data may be related to one or more parameters of the device, and the controller may be configured to use the default configuration data responsive to the determination of one or more parameters associated with that default configuration data. The default configuration data may be associated with one or more (typically two or more) conditions. The controller may initially be configured to use selected default configuration data to configure the impedance matching circuitry responsive to a determination that one or more (or all) of the conditions associated with the selected default configuration data are met. The default configuration data may comprise two or more default configuration sets, each of which is associated with a different condition.

Typically, the controller is configured in the learning mode to adjust the default impedance matching configuration applied to the impedance matching circuitry responsive to a detected impedance mismatch at the circuit interface by the impedance mismatch sensor. The controller may be configured to adjust the default impedance matching configuration applied to the impedance matching circuitry to provide customised impedance matching configurations until an impedance match is obtained at the circuit interface. Typically configuration data relating to (e.g. specifying) the customised impedance matching configuration applied to the impedance matching circuitry when the impedance match is obtained at the circuit interface is the configuration data stored in the user profile by the controller. The configuration data which provides the impedance match may replace corresponding default configuration data in the user profile.

It may be that the default configuration data is not initially customised for a user of the device. It may be that the default configuration data is customised for a particular hardware design (e.g. make or model) of the wireless communications device (typically before it is customised for a particular user of the device).

It may be that in the learning mode the controller is configured to group together configuration data relating to two or more (typically subsequent or consecutive) customised impedance matching configurations which provide impedance matching under different (but typically related) conditions (e.g. at different, but subsequent or consecutive, locations or when the wireless communications device communicates using different radio frequencies, such as different radio frequencies within the same band). The controller may be further configured to determine one or more predefined modes using the said configuration data relating to the said two or more customised impedance matching configurations. It may be that subsequent or consecutive customised impedance matching configurations are grouped together automatically, but more typically subsequent or consecutive customised impedance matching configurations are grouped together responsive to a determination that they are related to a pattern of usage of the device by the user (e.g. responsive to a determination that impedance matching was achieved using the said subsequent or consecutive customised impedance matching configurations two or more times).

It may be that the controller is provided in communication with a (third party) location information service (e.g. Google Maps) configured to provide location information relating to a current position of the device and/or relating to one or more (typically two or more) historical positions of the device. It may be that the controller is configured to customise a default user profile for the user using location information relating to historical positions of the device from a (third party) location information service. For example the controller may be configured to determine one or more location tracks relating to the device (or to the user of the device) using historical positioning data relating to historical positions of the device (or the user of the device) from the location information service (e.g. with which the user has an account). It may be that, initially, the controller is configured to associate default configuration data with the said location paths. In this case, the controller is typically configured to refine the said configuration data in the learning mode.

Preferably the impedance matching circuitry responds in real time to the application of a selected customised impedance matching configuration by the controller.

The baseband circuitry typically comprises baseband processing circuitry (e.g. a baseband processor).

The wireless communications device typically comprises a central processor. The central processor is typically configured to run an operating system of the wireless communications device. The central processor may comprise control logic, analog and mixed signal circuits, a state machine, centre controller, microprocessor, microcontroller or any other realization that is known by those skilled in the art.

It may be that the controller and/or the memory are provided as part of the wireless communications device. Alternatively, the controller and/or the memory may be provided on a server in communication with the wireless communications device. Alternatively, the controller and/or the memory may be distributed between the wireless communications device and a server in communication with the wireless communications device. The controller may be configured to apply the selected one of the customised impedance configurations to the impedance matching circuitry over a network (e.g. over a LAN, WAN or the internet).

It may be that the wireless communications device comprises baseband circuitry having baseband processing circuitry (e.g. a baseband processor) and wherein the controller comprises or employs the baseband processing circuitry (e.g. baseband processor).

This helps to increase the speed at which impedance matching can be achieved (particularly when the conditions associated with the customised impedance matching configurations comprise frequency conditions) because the baseband processing circuitry (e.g. baseband processor) has direct access to and/or control of the radio frequency channel (or frequency standard or frequency mode) on which the wireless communications device is communicating. In addition, location information can be readily obtained by the baseband processing circuitry (e.g. baseband processor), e.g. by comparing an identifier of one or more base stations with which the wireless communications device is communicating with a database of base-station locations (which may be provided in a memory of the wireless communications device or in a memory provided in a server in communication with the wireless communications device).

It may be that the wireless communications device comprises a central processor configured to run an operating system of the wireless communications device, and wherein the controller comprises or employs the central processor.

In some embodiments the controller comprises (or it may be that the controller employs) one or more processors on one or more server computers in data communication with the wireless communications device. In this case, it may be that a control signal is provided by the server(s) to the impedance matching circuitry (e.g. across a network) in order to apply a particular customised impedance matching configuration thereto.

Using existing processing power of the wireless communications device (e.g. baseband, central processor) or from an existing server, helps to reduce the cost of, and space required on the device by, the controller.

Nevertheless, in some embodiments the controller comprises (or employs) a dedicated processor (e.g. on the wireless communications device).

Typically the controller is coupled to the impedance matching circuitry by way of an interface circuit (e.g. analog to digital converter, serial-parallel interface, an application specific integrated circuit, other mixed signal circuit, MIPI RFFE interface or any other suitable interface circuit).

Typically the controller is coupled to the impedance matching circuitry through driving circuitry. For example, the driving circuitry may comprise amplification circuitry configured to amplify control signals from a processor of the controller to provide a control signal for tuning a component of the impedance matching circuitry having a tuneable impedance (reactance). The driving circuit may comprise an application specific integrated circuit whose function is to accept digital signals from the controller (processor) and output analog signals (e.g. voltages and/or currents) to one or more tuneable components of the impedance matching circuitry. The driving circuit may comprise an inductor based converter or linear regulator for example.

It will be understood that a position is typically a specific position (e.g. defined by co-ordinates) and that a locus is a broader area (e.g. around 10 m², 100 m² or 1 km²).

It will be understood that the said one or more conditions associated with the customised impedance matching configurations are typically related to (and typically affect) an impedance of the antenna module and/or one or more impedances within the circuitry.

It may be that a plurality of user profiles is provided in the memory. Each of the said plurality of user profiles is typically associated with the said wireless communications device. Each of the said plurality of user profiles is typically associated with a different user of the device. It may be that the controller is configured to select one of the said plurality of user profiles responsive to a determination of the identity of the user. The controller may be configured to determine the identity of the user, for example, from an identification check performed by an operating system of the device (e.g. a fingerprint analysis or other log-in procedure).

It may be that a plurality of circuit interfaces are provided, each of the said plurality of circuit interfaces being provided within the circuitry or between the circuitry and the antenna module. The wireless communications apparatus (e.g. the wireless communications device) may comprise impedance matching circuitry configurable to adjust an impedance match at each of the said plurality of circuit interfaces, wherein the controller is configured to use configuration data from the user profile to configure the impedance matching circuitry so as to adjust the impedance match at a plurality of the said circuit interfaces responsive to a determination of one or more parameters of the device associated with that configuration data. For example, the impedance matching circuitry may comprise a plurality of impedance matching circuits (e.g. one or more impedance matching circuits per said circuit interface). It may be that a plurality of impedance matching circuits is reconfigured in accordance with configuration data from the user profile responsive to a determination of one or more parameters of the device associated with that configuration data. Different configuration data may be selected in respect of different matching circuits.

A second aspect of the invention provides a method of adjusting an impedance match at a (RF) circuit interface of a wireless communications device comprising (RF) circuitry in (data) communication with an antenna module, the (RF) circuit interface being provided within the (RF) circuitry or between the (RF) circuitry and the antenna module, the method comprising: providing impedance matching circuitry configurable to adjust an impedance match at the (RF) circuit interface; providing a user profile associated with the wireless communications device, or with a user of the wireless communications device (typically customised in accordance with one or more usage patterns of the wireless communications device by the user), the user profile comprising configuration data relating to one or more impedance matching configurations of the impedance matching circuitry (typically customised for the user associated with the user profile or a user of the device), the configuration data being associated with one or more parameters of the wireless communications device; and using configuration data from the user profile to configure the impedance matching circuitry responsive to a determination of one or more (or all of the) parameters of the device associated with that configuration data.

It will be understood that any essential or optional features of the first aspect of the invention are also applicable to the second aspect of the invention and vice versa.

The method may comprise using selected configuration data from the user profile to configure the impedance matching circuitry responsive to a determination that one or more conditions associated with that configuration data are or will be met.

The method may comprise predicting a change in one or more parameters of the wireless communications device and using selected configuration data from the user profile to configure the impedance matching circuitry responsive to the said predicted change.

The method may comprise providing the user profile with one or more predefined modes. The method may further comprise entering one of the said predefined modes (e.g. responsive to a determination that one or more predefined mode conditions associated with that mode are or will be met). The method may comprise, in a said predefined mode, predicting a change in one or more parameters affecting the impedance match at the circuit interface. The method may further comprise, in a said predefined mode, determining that one or more (or two or more or all of the) conditions associated with a customised impedance matching configuration are or will be met based on one or more said predictions. The method may further comprise, in a said predefined mode, using selected configuration data from the user profile to configure the impedance matching circuitry responsive to a prediction that one or more (or two or more or all of the) conditions associated with that configuration data are or will be met.

The method may further comprise, in a said predefined mode related to a location track (see above), determining that one or more (or two or more or all of the) conditions associated with selected configuration data are or will be met based on one or more parameters from or associated with the location track.

The method may comprise using selected configuration data from the user profile to configure the impedance matching circuitry in a said predefined mode responsive to a determination that one or more secondary condition(s) associated with that configuration data are or will be met.

The method may comprise (in a said predefined mode) using first selected configuration data from the user profile to configure the impedance matching circuitry responsive to a determination that the wireless communications device occupies (or will occupy) a first position on a location track and using second selected configuration data from the user profile to configure the impedance matching circuitry responsive to a determination that the wireless communications device occupies (or will occupy) a second position or locus on the track.

The method may comprise (in a said predefined mode) applying a first selected customised impedance matching configuration to the impedance matching circuitry responsive to a determination that the wireless communications device is on (or adjacent to) the track (or at a particular position or locus on the track) and applying a second selected customised impedance match configuration to the impedance matching circuitry a predetermined period of time after the application of the first selected customised impedance matching configuration.

In another embodiment, the method may comprise (in a said predefined mode) using first selected configuration data from the user profile to configure the impedance matching circuitry responsive to a determination that the wireless communications device is on (or adjacent to) the track and using second selected configuration data from the user profile to configure the impedance matching circuitry responsive to a determination that the device has moved and/or responsive to a direction of movement of the device.

The method may comprise remaining in a predefined mode for a predetermined period of time. Additionally or alternatively, the method may comprise remaining in a predefined mode until it is determined that one or more of the conditions associated with the said predefined mode are not met (or that one or more exit conditions are met).

The method may comprise (repeatedly or periodically) checking whether one or more conditions associated with the predefined mode are met. The method may comprise checking secondary conditions more frequently (at least for a period of time or until an event occurs) than conditions associated with the said predefined mode.

The method may comprise increasing or decreasing a frequency (e.g. regularity) with which checking is performed as to whether conditions associated with the predefined mode are met responsive to determination of one or more parameters. For example, the frequency (e.g. regularity) with which such checks are performed may increase or decrease responsive to a determined position of the device and/or responsive to a determination that the device is moving and/or responsive to a direction of movement of the device and/or responsive to a time (e.g. a time of day or day of the week).

The method may comprise increasing the frequency (e.g. regularity) with which checks are made as to whether the wireless communication device occupies a position or locus on a location track responsive to a determination that the wireless communication device is at a position near a location track or approaching a location track at a time associated with a pattern of movement of the device with which the location track is associated.

The method may comprise using first selected configuration data to configure the impedance matching circuitry responsive to a predicted change in one or more parameters affecting the impedance match at the circuit interface. The method may further comprise using second selected configuration data to configure the impedance matching circuitry responsive to confirmation that the predicted parameter change has occurred (e.g. when the said predicted change would cause one or more conditions associated with that second configuration to be met). Typically the second selected configuration data provides a more accurate impedance match in the event that the predicted parameter change occurs than the first selected configuration data. Typically the first selected configuration data provides a more accurate impedance match in the event that the said parameter remains constant (as opposed to changing as predicted) than the second selected configuration data. Typically the first selected configuration data provides a more accurate impedance match in the event that the predicted parameter change occurs than the impedance matching configuration of the impedance matching circuitry immediately prior to the impedance matching configuration derived from the first selected configuration data.

The method may comprise using selected configuration data from the user profile to configure the impedance matching circuitry responsive to a determination of an impedance mismatch at the circuit interface (e.g. by an impedance mismatch sensor).

The method may comprise determining refined or new customised impedance matching configurations in a learning mode. The method may further comprise storing configuration data relating to determined new or customised impedance matching configurations in the user profile in the said learning mode. The method may comprise adjusting the impedance matching configuration of the impedance matching circuitry responsive to a detected impedance mismatch by the impedance mismatch sensor. The impedance matching configuration is typically adjusted until an impedance match is detected by the impedance mismatch sensor. The method may further comprise storing configuration data relating to the impedance matching configuration which provides the impedance match in the user profile. The method may further comprise storing one or more parameters of the device and/or conditions in the user profile which may be associated with the said configuration data being stored. The parameters and conditions may comprise any one or combination of the parameters and conditions described above (or indeed any other suitable parameters/conditions).

The method may comprise processing signals from one or more pressure and/or touch and/or temperature sensors of the wireless communications device to determine or update one or more characteristics relating to a way of holding or wearing the wireless communications device which is preferred by the user (optionally for a particular action, such as making a call, browsing the internet, interacting with the screen etc.). For example, the determined characteristics may relate to a way of holding or wearing the wireless communications device which is adopted with the greatest frequency by the user. It may be that the method further comprises determining or updating configuration data of the user profile responsive to the determination or the updating of one or more characteristics relating to the said way of holding or wearing the wireless communications device which is preferred by the user.

A third aspect of the invention provides wireless communications apparatus comprising:
a wireless communications device comprising an antenna module, (RF) circuitry in communication with the antenna module, a (RF) circuit interface within the (RF) circuitry or between the (RF) circuitry and the antenna module, impedance matching circuitry configurable to adjust an impedance match at the (RF) circuit interface and an impedance mismatch sensor configured to detect an impedance mismatch at the circuit interface;
and a controller in (e.g. data) communication with the impedance mismatch sensor (and typically in (e.g. data) communication with the impedance matching circuitry), the controller being configured to determine an impedance matching configuration of the impedance matching circuitry customised for a user of the wireless communications device for reducing a detected impedance mismatch at the (RF) circuit interface by the impedance mismatch sensor,
   wherein the controller is further configured to customise a user profile (associated with the device or with a user of the device, typically in accordance with one or more usage patterns of the device by the user) by storing configuration data relating to the said determined customised impedance configuration in the user profile (e.g. data from which the said customised impedance matching configuration can be determined).

The wireless communications apparatus according to the third aspect of the invention may comprise any of the essential or optional features of the wireless communications apparatus according to the first aspect of the invention.

The controller is typically configured to adjust an impedance matching configuration applied to the impedance matching circuitry, typically responsive to an impedance mismatch detected by the impedance mismatch sensor.

The wireless communications apparatus typically comprises a feedback loop connected to the controller from the circuit interface by way of the impedance mismatch sensor. The controller is typically configured to adjust the impedance matching configuration applied to the impedance matching circuitry until an impedance match (or at least an approximate impedance match) is obtained at the circuit interface. Typically the impedance matching configuration applied to the impedance matching circuitry when the impedance match is obtained at the circuit interface is the impedance matching configuration which is stored in the user profile by the controller.

It will be understood that by “impedance match”, we refer to an impedance match for the transfer of maximum (RF) signal power across the circuit interface, typically from a source on a first side of the interface (e.g. the RF circuitry) to a load (e.g. antenna module) on a second side of the interface opposite the first side. That is, the complex impedance looking towards the source on the first side of the interface must be a complex conjugate impedance of the load on the second side of the interface. However, it will also be understood that we do not necessarily mean a perfect impedance match, and that the term “impedance match” would also include an approximate impedance match (for the transfer of maximum (RF) signal power across the circuit interface) which is within an acceptable range of a perfect impedance match (for the transfer of maximum power across the circuit interface). The acceptable range may be selected responsive to one or more user requirements, or to one or more wireless device specifications. The acceptable range may be defined with reference to a voltage standing wave ratio (VSWR) at the circuit interface. It may be that the acceptable range comprises a condition specifying that VSWR is less than 3, more typically VSWR is less than 2, in some cases VSWR is less than 1.5, and in some cases VSWR is less than 1.2. It may be that, the more accurate the impedance match required at the interface, the longer it takes to achieve. It may be preferable in some cases to achieve the desired VSWR more quickly at a cost of a less accurate impedance match. In other cases, it may be preferable to achieve a more accurate impedance match at a cost of further delay before the required impedance match is achieved.

By “improving” the impedance match (or providing a “more accurate” impedance match or “reducing an impedance mismatch”) at the circuit interface, we refer to adjusting the impedance to bring it closer to a perfect impedance match for the transfer of maximum power across the circuit interface (i.e. to adjust the load impedance on the second side of the interface to bring it closer to the complex conjugate of the source impedance on the first side of the interface, or vice versa).

The controller is typically configured to store one or more determined parameters and/or one or more conditions in the user profile which are associated with the impedance matching configuration applied to the impedance matching circuitry when the impedance match is obtained at the circuit interface. The parameters and conditions may comprise any one or any combination of the parameters and conditions described above (or indeed any other suitable parameters or conditions). For example, the parameters and conditions stored in the user profile may relate to one or more of: a (radio) frequency of communication of the wireless communications device when the impedance match was achieved (as discussed above in respect of the first aspect of the invention, the wireless communications device may comprise baseband circuitry in data communication with the controller, and the controller may be configured to determine a frequency of communication of the wireless communications device from the baseband circuitry); a location of the wireless communications device when the impedance match was achieved (as discussed above the location of the wireless communications device may be estimated from location information received from the baseband circuitry or from a positioning module); one or more (preferably two or more) sensor conditions relating to signals received from one or more (or two or more) sensors of the wireless communications device (or data derived therefrom) when the impedance match was achieved.

It may be that, in the learning mode, the controller is configured to receive signals from one or more pressure and/or touch and/or temperature sensors of the wireless communications device and to determine or update one or more characteristics stored in the user profile relating to a way of holding or wearing the wireless communications device which is preferred by the user (or which is preferred by the user for a particular action, such as making a call, browsing the internet, interacting with the screen etc.). For example, the determined characteristics may relate to a way of holding or wearing the wireless communications device which is adopted with the greatest frequency by the user (or which is adopted with the greatest frequency by the user for a particular action, such as making a call, browsing the internet, interacting with the screen etc.). It may be that the controller is further configured to determine or update configuration data of the user profile responsive to the determination or the updating of one or more characteristics relating to the said way of holding or wearing the wireless communications device which is preferred by the user.

It may be that a plurality of characteristics are stored in the user profile, each of the characteristics relating to a different way in which the user interacts with the device. For example, a characteristic may be provided which is related to the way in which the user holds, wears or interacts with the wireless communications device during a call (e.g. the user may hold, wear or interact with the device in a particular way during a call). Additionally or alternatively a characteristic may be provided which is related to the way in which the user holds, wears or interacts with the wireless communications device when browsing the internet (e.g. the user may hold the device in one hand and interact with one or more input devices, such as a touch screen, of the device with the same hand or with the other hand). Additionally or alternatively one or more characteristics may be provided for when the user holds, wears or interacts with the device in a portrait orientation. Additionally or alternatively one or more characteristics may be provided for when the user holds, wears or interacts with the device in landscape orientation. The way in which the user interacts with the device may include inputting data into the device, e.g. using a touch screen, trackpad, finger, mouse, keyboard, voice control and so on. It will be understood that such interaction could affect the impedance of the antenna, which would require an adjustment to the impedance match at the interface. Typically the method comprises using configuration data associated with a said characteristic to configure the impedance matching circuitry responsive to a determination (typically taking into account said one or more parameters) that the user is holding the device in accordance with the said characteristic.

As set out in relation to the first aspect of the invention, the controller may be configured to use selected configuration data from the user profile to configure the impedance matching circuitry responsive to a determination that one or more (or two or more or all of the) conditions associated with the said configuration data are or will be met.

It may be that the user profile initially comprises default configuration data relating to one or more default impedance matching configurations. The default configuration data may be related to one or more parameters of the device, and the controller may be configured to use the default configuration data responsive to the determination of one or more parameters associated with that default configuration data. The default configuration data may be associated with one or more (typically two or more) conditions. The controller may initially be configured to use selected default configuration data to configure the impedance matching circuitry responsive to a determination that one or more (or all) of the conditions associated with the selected default configuration data are met. The default configuration data may comprise two or more default configuration sets, each of which is associated with a different condition.

Typically, the controller is configured in the learning mode to adjust the default impedance matching configuration applied to the impedance matching circuitry responsive to a detected impedance mismatch at the circuit interface by the impedance mismatch sensor. The controller may be configured to adjust the default impedance matching configuration applied to the impedance matching circuitry to provide customised impedance matching configurations until an impedance match is obtained at the circuit interface. Typically configuration data relating to (e.g. specifying) the customised impedance matching configuration applied to the impedance matching circuitry when the impedance match is obtained at the circuit interface is the configuration data stored in the user profile by the controller. The configuration data which provides the impedance match may replace corresponding default configuration data in the user profile.

It may be that the default configuration data is not initially customised for a user of the device. It may be that the default configuration data is customised in accordance with the hardware configuration or design (e.g. make, model, style, form-factor, functionality, types of sensor modules provided) of the wireless communications device. The controller may be configured to customise the default configuration data in accordance with the hardware configuration or design of the wireless communications device (e.g. before any personal customisation is performed).

The controller may be configured to calibrate a (e.g. an existing customised or default) user profile in accordance with device specific (typically relating to the hardware of the device) calibration data relating to the wireless communications device.

It may be that at least part of the controller is provided on a server computer. The controller may be configured to determine when the user is using a new (alternative or additional) wireless communications device (e.g. as part of a registration process of the new wireless communications device). The (or a separate) controller may be configured to adjust (e.g. calibrate) the user profile in accordance with device specific calibration data relating to (e.g. the hardware configuration or design of) the new wireless communications device. In this way, differences between the new device and a previous device can be taken into account in the updated user profile, and the performance of the new wireless communications device can be improved without having to re-learn impedance matching configurations and predefined modes from scratch (although it will be appreciated that some refinement may be required).

It may be that the said wireless communications device is a first wireless communications device. The controller may be configured to re-calibrate the user profile in accordance with device specific calibration data relating to (e.g. the hardware configuration or design of) a second wireless communications device different from the first wireless communications device responsive to a determination that a user associated with the first wireless communications device is using, or will be using, the second wireless communications device.

It may be that the controller is configured to group together configuration data relating to two or more (typically subsequent or consecutive) customised impedance matching configurations which provide impedance matching under different (but typically related) conditions (e.g. at different, but subsequent or consecutive, locations or when the wireless communications device communicates using different radio frequencies, such as different radio frequencies within the same band). The controller may be further configured to determine one or more predefined modes using the said configuration data relating to the said two or more customised impedance matching configurations. It may be that subsequent or consecutive customised impedance matching configurations are grouped together automatically, but more typically subsequent or consecutive customised impedance matching configurations are grouped together responsive to a determination that they are related to a pattern of usage of the device by the user (e.g. responsive to a determination that impedance matching was achieved using the said subsequent or consecutive customised impedance matching configurations two or more times).

A fourth aspect of the invention provides a method of customising (profiling) an impedance matching scheme for a wireless communications device, the method comprising: providing a wireless communications device comprising an antenna module, (RF) circuitry in communication with the antenna module, a (RF) circuit interface within the (RF) circuitry or between the (RF) circuitry and the antenna module, impedance matching circuitry configurable to adjust an impedance match at the (RF) circuit interface and an impedance mismatch sensor configured to detect an impedance mismatch at the (RF) circuit interface, the method comprising determining an impedance matching configuration of the impedance matching circuitry customised for a user of the wireless communications device for reducing a detected impedance mismatch at the (RF) circuit interface by the impedance mismatch sensor; and customising a user profile (typically associated with the device or with a user of the device, typically in accordance with one or more usage patterns of the device by a user) by storing configuration data relating to the said determined customised impedance configuration in the user profile.

Typically the method comprises calibrating the user profile in accordance with device specific (typically hardware design or configuration specific) calibration data relating to the wireless communications device.

A fifth aspect of the invention provides wireless communications apparatus comprising:
a wireless communications device comprising an antenna module, (RF) circuitry in communication with the antenna module, a (RF) circuit interface within the (RF) circuitry or between the (RF) circuitry and the antenna module and impedance matching circuitry configurable to adjust an impedance match at the circuit interface; and
a controller configured to predict a change in the impedance match at the (RF) circuit interface, or a change in one or more parameters capable of causing a change in the impedance match at the (RF) circuit interface, and to adapt an impedance matching configuration of the impedance matching circuitry in accordance with said predicted change to thereby adjust (improve) the said impedance match at the (RF) circuit interface.

The wireless communications apparatus according to the fifth aspect of the invention may comprise any one or more, or any combination of, the essential or optional features of the wireless communications apparatus according to the first aspect of the invention.

By predicting a change in impedance and adapting an impedance matching configuration in accordance with said predicted change (typically before the said predicted change occurs), large or abrupt impedance mismatches can be prevented as the impedance mismatch can be tackled gradually by gradually changing the impedance from a first configuration to a second configuration.

In some embodiments, the controller may be configured to further adjust the impedance of the impedance matching circuitry to thereby improve the impedance match between the circuitry and the antenna module responsive to a confirmation of said predicted change.

Typically the controller is configured to predict a change in the impedance match at the circuit interface, or a change in one or more parameters capable of causing a change in the impedance match at the circuit interface, responsive to a detected change in a position of the wireless communications device. Typically the controller is further configured to adapt the impedance matching configuration of the impedance matching circuitry in accordance with said predicted change to thereby adjust the said impedance match at the circuit interface.

It may be that the controller is configured to monitor a position of the wireless communications device and to predict a change in the impedance match at the circuit interface, or a change in one or more parameters capable of causing a change in the impedance match at the interface, responsive to a detected position (or two or more, e.g. subsequent or consecutive, detected positions) of the wireless communications device. For example, it may be that the controller is configured to monitor a position of the wireless communications device and to predict a change in the impedance match at the circuit interface, or a change in one or more parameters capable of causing a change in the impedance match at the circuit interface, responsive to a determination that the wireless communications device is following a predetermined location path and/or that the wireless communications device is following a particular portion of a predetermined location path. Typically the controller is configured to adapt the impedance matching configuration of the impedance matching circuitry in accordance with said predicted change to thereby adjust the said impedance match at the circuit interface.

A sixth aspect of the invention provides a method of adjusting an impedance match at a (RF) circuit interface in a wireless communications device comprising (RF) circuitry in communication with antenna module, the circuit interface being provided within the (RF) circuitry or between the (RF) circuitry and the antenna module, the method comprising: predicting a change in an impedance match at the interface, or a change in one or more parameters capable of causing a change in an impedance match at the interface, and adapting an impedance matching configuration of the impedance matching circuitry in accordance with said predicted change to thereby adjust (improve) the said impedance match at the circuit interface.

The method may further comprise: detecting a change in a position of the wireless communications device; and predicting a change in the impedance match at the interface, or in one or more parameters capable of causing a change in an impedance match at the circuit interface, responsive to the said detected change in position of the wireless communications device. The method may further comprise adapting the impedance matching configuration of the impedance matching circuitry in accordance with said predicted change to thereby adjust (improve) the said impedance match at the circuit interface.

It may be that the method comprises: monitoring a position of the wireless communications device; and predicting a change in the impedance match at the interface, or in one or more parameters capable of causing a change in an impedance match at the interface, responsive to a detected position (or two or more e.g. subsequent or consecutive detected positions) of the wireless communications device. For example the method may comprise monitoring a position of the wireless communications device and predicting a change in the impedance match at the interface, or a change in one or more parameters capable of causing a change in the impedance match at the interface, responsive to a determination that the wireless communications device is following a predetermined location path and/or that the wireless communications device is following a particular portion of a predetermined location path. The method may further comprise adapting the impedance matching configuration of the impedance matching circuitry in accordance with said predicted change to thereby adjust the said impedance match at the interface.

It will be understood that the “modules” discussed in this specification could be implemented in hardware, in software or in a combination of hardware and software.

The preferred and optional features discussed above are preferred and optional features of each aspect of the invention to which they are applicable.

### DESCRIPTION OF THE DRAWINGS

An example embodiment of the present invention will now be illustrated with reference to the following Figures in which:

FIG. 1 is a block diagram of a simplified transceiver antenna circuit within a wireless communications device;

FIG. 2 shows a number of plots of distorted total field gain of an exemplary antenna versus frequency of operation of the antenna for different positions of the antenna relative to a human body;

FIG. 3 shows a number of plots of return loss versus the frequency of operation of the antenna, each plot showing the effects at different distances of the antenna from the human body;

FIG. 4 provides plots of total radiation pattern of the antenna for six different positions of a user's fingers on the casing of a “flip” style mobile phone at two different radio frequencies;

FIG. 5 is a block diagram of an impedance matching system;

FIG. 6 is a block diagram similar to that of FIG. 5 but showing more details of the control system;

FIG. 7 is a more detailed block diagram of part of the impedance matching system of FIGS. 5 and 6;

FIG. 8 is a (linear) plot of capacitance against control voltage for a tunable MEMS capacitor;

FIG. 9 is a Smith chart showing a smooth transition between an impedance mismatch and an impedance match achieved by tuning the capacitance of the MEMS capacitor of FIG. 8;

FIG. 10 is an amended version of the block diagram of FIG. 6 also showing the baseband circuitry;

FIG. 11 is an amended version of the block diagram of FIG. 6 also showing the central processor of the wireless communications device;

FIG. 12 is an amended version of the block diagram of FIG. 6 also showing a processor in the cloud/on a server computer;

FIG. 13 is an illustration of a user profile of the database shown in FIGS. 5-7, 10-12;

FIG. 14 is an illustration of a predefined mode of a user profile of the database shown in FIGS. 5-7, 10-13;

FIG. 15 is an amended version of the block diagram of FIG. 6 also showing the sensor and baseband inputs;

FIG. 16 is a flow diagram illustrating an algorithm which may be employed by the controller of the impedance matching system to achieve an impedance match using sensor data;

FIG. 17 is a block diagram illustrating the use of the user profile together with sensors on the wireless communications device to achieve an impedance match;

FIG. 18 is a block diagram illustrating the use of the user profile together with location information provided by a GPS module or the baseband circuitry to achieve an impedance match;

FIG. 19 is a block diagram illustrating the use of the user profile together with hardware design data from the manufacturer of the wireless communications device and sensors on the wireless communications device to achieve an impedance match;

FIG. 20 is a block diagram illustrating the use of the user profile together with hardware design data, location data, sensor data and baseband data to achieve an impedance match;

FIG. 21 is a flow diagram illustrating an initial algorithm which may be employed to achieve an impedance match before a user profile has been built;

FIG. 22 is a flow diagram illustrating an algorithm which can be used to achieve an impedance match and to build the user profile using baseband, location and sensor data;

FIG. 23 is a flow diagram illustrating an algorithm which can be used to achieve an impedance match and to build a user profile using baseband data;

FIG. 24 is a flow diagram illustrating an algorithm which can be used to achieve an impedance match using one or more predefined modes of the user profile and to build one or more predefined modes of the user profile; and

FIG. 25 is a flow diagram illustrating an algorithm which can be used to update a user profile when a user associated with that user profile acquires a new wireless communications device.

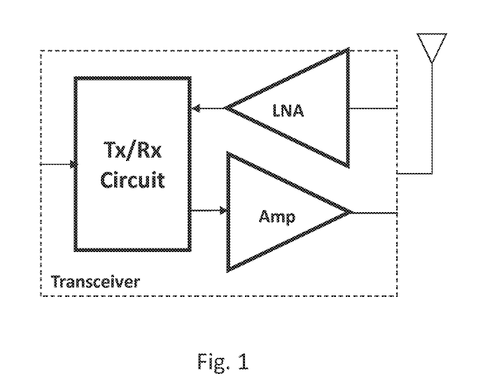

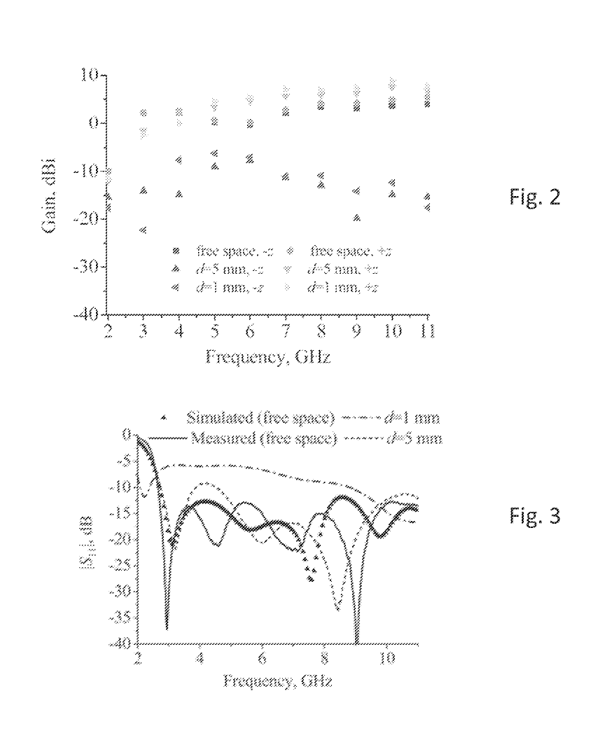

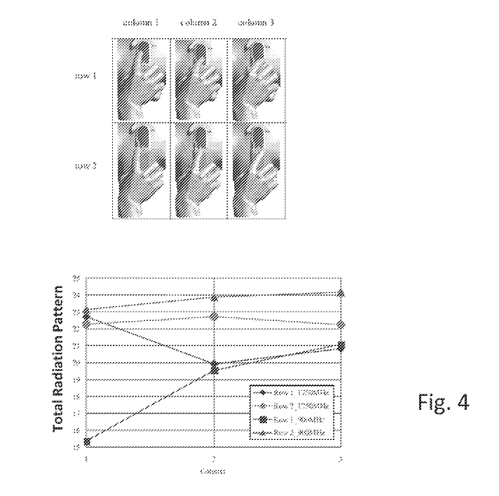

### DETAILED DESCRIPTION OF AN EXAMPLE EMBODIMENT

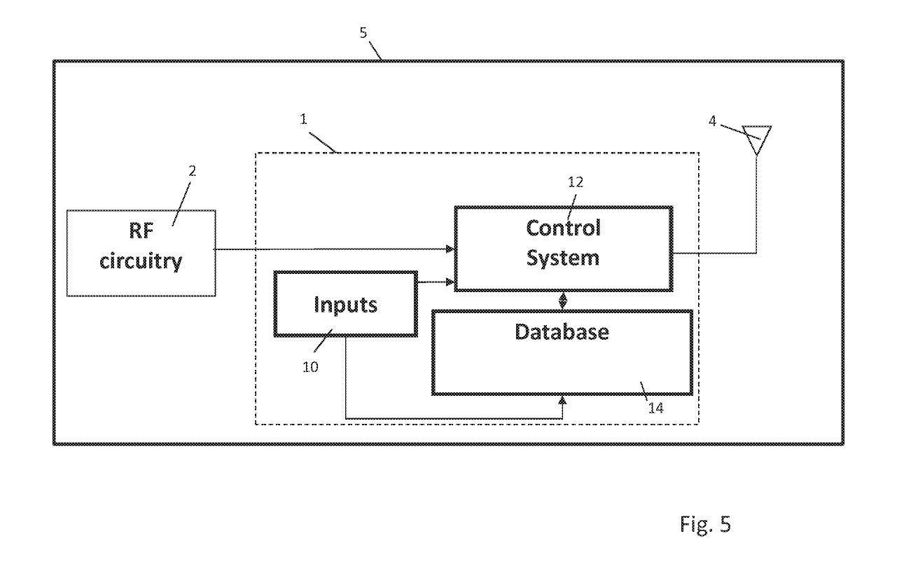

FIG. 5 is a simplified block diagram of an impedance matching system 1 for adjusting an impedance match at a circuit interface between RF circuitry 2 and an antenna module 4 within the RF front end of a wireless communications device 5 for transmitting and/or receiving radio communications signals to and/or from the wireless communications device. The wireless communications device 5 could be any wireless communications device 5 (e.g. a handheld or wearable wireless communications device, mobile wireless communications device, mobile phone, mobile smartphone, phablet, tablet, laptop or netbook computer, picocell, femtocell, base station, smart watch, router or repeater), but in the description below it will be assumed that the wireless communications device 5 is a mobile smartphone.

The RF circuitry 2 shown in FIG. 5 comprises RF transmitter circuitry 2 configured to drive the antenna (e.g. in a transmitter mode). Typically, the RF transmitter circuitry comprises an RF modulator receiving a first, modulating input from a local oscillator and a second, signal input from a digital to analogue converter and a power amplifier configured to receive modulated signals from the RF modulator and to provide amplified, modulated signals to the antenna module 4. Further intermediate signal conditioning circuitry is typically provided. The RF circuitry 2 may additionally or alternatively comprise RF receiver circuitry 2 configured to process signals received by the antenna module 4 (e.g. in a receiver mode). In this case, the RF receiver circuitry typically comprises a low noise amplifier configured to receive and amplify detected signals from the antenna module 4 and to provide the amplified signals to a demodulator (e.g. mixer) which receives the amplified signals as a first input and a demodulating signal from a local oscillator as a second input. The demodulated signal is then typically passed through an analogue to digital converter. Further intermediate signal conditioning circuitry is typically provided.

The antenna module 4 may comprise one or more antennae for transmitting and/or receiving radio communications signals (e.g. the antenna module may comprise an antenna array comprising a plurality of antennae). The antenna module 4 may comprise one or more transmitter antennae configurable to transmit radio communications signals and/or one or more receiver antenna configurable to receive radio communications signals and/or one or more transceiver antenna configurable to transmit and receive radio communications signals (typically in different modes). In some cases the antenna module 4 may comprise a single transceiver antenna.

The impedance matching control system 1 may be provided fully on the wireless communications device, or the impedance matching control system 1 may be distributed between the wireless communications device and one or more server computers in data communication with the wireless communications device.

The impedance matching control system 1 comprises inputs 10 in data communication with a control system 12 and with a database 14. The database 14 is also in data communication with the control system 12. The control system 12 is in communication with the antenna module 4. The inputs 10, control system 12 and database 14 are configurable to adjust an impedance mismatch between the RF circuitry 2 and the antenna module 4.

Although the exemplary embodiment described herein assumes that the impedance match being corrected is at an interface between the RF circuitry 2 and the antenna module 4, it will be understood that impedance matching at other circuit interfaces within the RF circuitry is also important for optimising the power efficiency and performance of the device. Accordingly, the present invention may be additionally or alternatively applied to any other circuit interface within the wireless communications device 5 (typically within the RF front end), such as a circuit interface provided within the RF circuitry (for example but not exclusively between RF modulator circuitry and the power amplifier or between the low noise amplifier and RF demodulator circuitry).

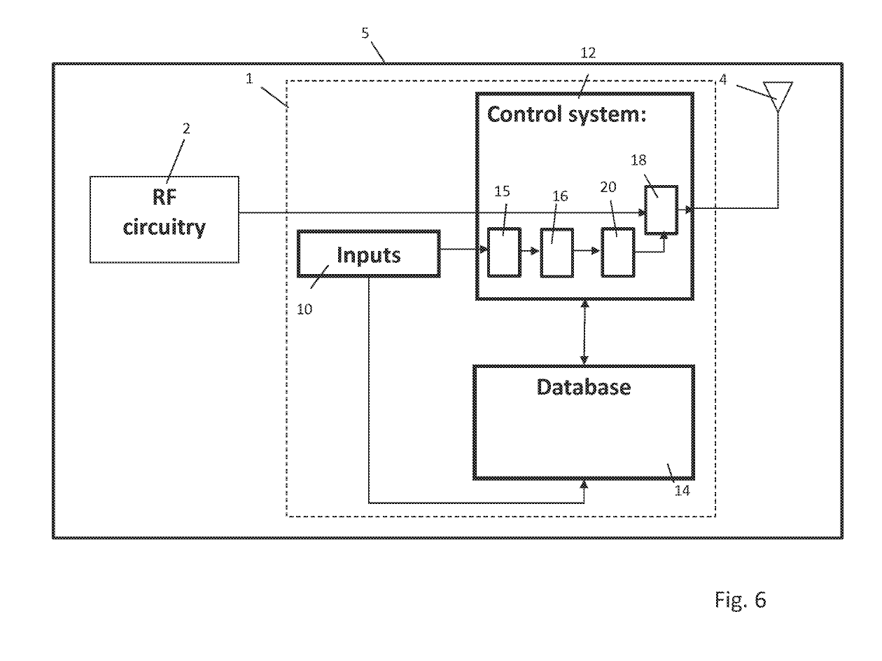

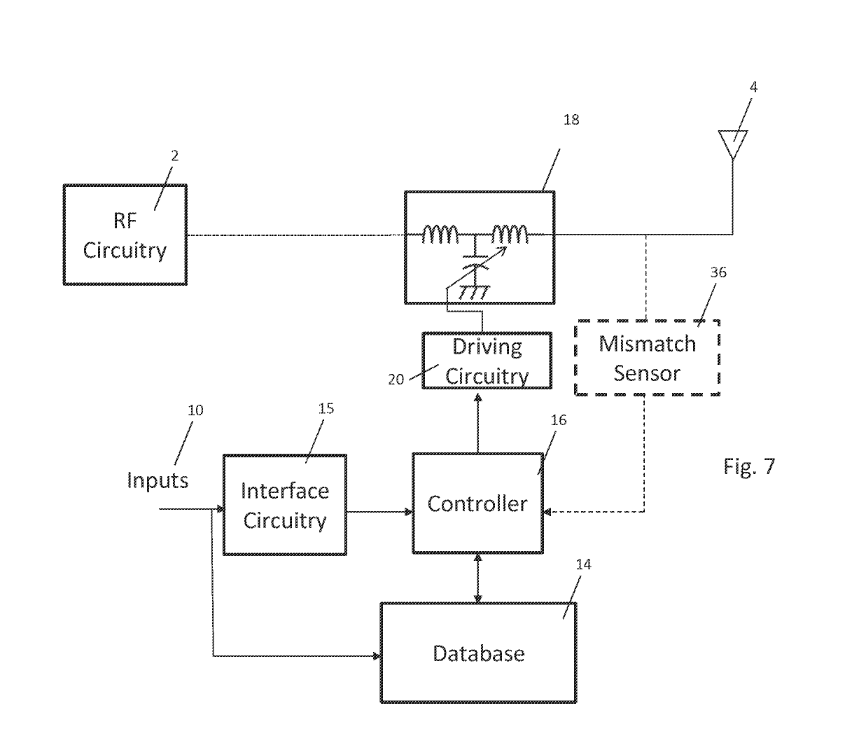

As shown in FIGS. 6 and 7, the control system 12 comprises interface circuitry 15 connected between the inputs 10 and a controller 16, the interface circuitry 15 being configured to convert signals received from the inputs 10 to a format readable by a controller 16. For example, the inputs may comprise analog signals and the controller 16 may comprise a digital signal processor. In this case, the interface circuitry 15 may comprise an analog to digital converter (ADC). The controller 16 is provided in communication with tuneable impedance matching circuitry 18, which has a reconfigurable impedance matching configuration (see below), through (by way of) driving circuitry 20. The driving circuitry 20 is configured to convert signals output by the controller 16 into a format suitable for adjusting the impedance matching configuration of the impedance matching circuitry 18. For example the driving circuitry 20 may comprise one or more amplifiers configured to amplify signals output by the controller 16 to a format suitable for adjusting an impedance of an impedance matching network of the impedance matching configuration. The controller 16, impedance matching circuitry 18 and driving circuitry 20 are shown in more detail in FIG. 7.

The impedance matching circuitry 18 is connected (indeed the impedance matching circuitry 18 is provided at the interface) between the RF circuitry 2 and the antenna module 4. Indeed as shown in FIG. 7 the RF circuitry 2 is connected to the antenna module 4 through (by way of) the impedance matching circuitry 18. The interface and the impedance matching circuitry 18 are provided in an RF signal path extending through the RF circuitry 2 to the antenna module 4.

As discussed above in the Background section, an impedance match at the circuit interface between the RF circuitry 2 and the antenna module 4 optimises electrical power transfer between them (to thereby minimise electrical power consumption of the wireless communications device, and to thereby maximise battery life) and/or optimises the communications performance of the antenna, and therefore of the device. In the case of a transmitting antenna (or a transceiver antenna in transmitting mode), the required impedance match is (in the present, exemplary embodiment) between an output impedance of the RF circuitry 2 (which would typically be 500) and an input impedance of the antenna module 4. It will be understood that, if there is a transmission line between the RF circuitry 2 and the antenna module 4, it may be that the required impedance match is between the characteristic (output) impedance of the transmission line and the input impedance of the antenna module 4 (or between the RF circuitry 2 and an input impedance of the transmission line). In the case of a receiving antenna (or a transceiver antenna in receiving mode) the required impedance match is (in the present, exemplary embodiment) between an output impedance of the antenna module 4 and an input impedance of the RF circuitry 2. It will be understood that, if there is a transmission line between the antenna module 4 and the RF circuitry 2, it may be that the required impedance match is between an output impedance of the antenna module 4 and the characteristic (input) impedance of the transmission line (or between an output impedance of the transmission line and an input impedance of the RF circuitry 2).

Although attempts may be made to minimise the impedance mismatch at the circuit interface between the RF circuitry 2 and the antenna module 4, this is not typically possible for mobile smartphones because the impedance of the antenna module 4 as seen by the RF circuitry 2 is typically affected by changes in one or more of a number of different parameters of the device. For example, the impedance of the antennae of the antenna module 4 is typically frequency dependent. Accordingly, the impedance of the antenna module 4 as seen by the RF circuitry 2 typically varies with the radio frequency at which the antenna module 4 transmits or receives radio frequency signals. It will be understood that the frequency at which mobile smartphones are required to transmit/receive radio communications signals is subject to change depending on a frequency mode of operation (e.g. radio communications conforming to the 2.5G, 3G or 4G standards), the frequency band on which it is operating and the frequency channel within the frequency band on which it is operating. It will also be understood that the frequency channel on which the smartphone is operating is typically location dependent. Furthermore, external objects interacting with the wireless communications device can affect the impedance of the antenna module 4 as seen by the RF circuitry 2. For example, a user's fingers touching an external surface of the wireless communications device, or one or more antennae of the antenna module 4 itself, or the presence of a human body (or other object, such as the pocket of a user or a table), such as the head of a user when the user is making a call, can cause a significant change in the impedance of the antenna module 4 as seen by the RF circuitry 2. Different users have different effects on the impedance match. Accordingly, it is necessary for the impedance matching circuitry 18 to be configurable so that impedance mismatches at the circuit interface between the RF circuitry 2 and the antenna module 4 can be corrected dynamically according to different situations.

The impedance matching circuitry 18 comprises a first inductor 18a (typically having a fixed inductance) in series with a variable capacitor 18b (having a variable capacitance) connected in parallel with a second inductor 18c (also typically having a fixed inductance). Signals from the RF circuitry 2 pass through the first inductor 18a and the parallel combination of the variable capacitor 18b and the second inductor 18c before being fed to the antenna module 4. The variable capacitor 18b may be a single capacitor having a capacitance controlled by voltage and/or current control signals from the controller 16 and driving circuitry 20 or, more typically, the variable capacitor 18b may comprise a bank of variable MEMS capacitors, each having a capacitance which is controllable by voltage and/or current driving signals from the controller 16 and driving circuitry 20, connectable in parallel with each other via one or more respective switches (e.g. one or more switches per MEMS capacitor). Whether the switches are open (de-activated) or closed (activated) is controlled by voltage and/or current signals from the controller 16 and driving circuitry 20. In this case, the capacitance of the variable capacitor 18b can be changed by controlling the capacitances of the individual capacitors within the bank and by selecting how many of the variable MEMS capacitors are connected in parallel by activating and deactivating their respective switches as required. The variable capacitor 18b thus has a tuneable impedance controllable by a (typically voltage or current) control signal from the driving circuitry 20 (which as explained above is in turn controlled by the controller 16). By changing the impedance of the variable capacitor 18b, the impedance match at the circuit interface between the RF circuitry 2 and the antenna module 4 can be adjusted (e.g. the input impedance of the antenna module as seen by the RF circuitry can be changed to better match the input impedance of the antenna module 4 with the output impedance of the RF circuitry and/or the output impedance of the RF circuitry 2 as seen by the antenna module 4 can be changed to better match the input impedance of the antenna module 4).

It will be understood that any suitable alternative impedance matching circuitry topology could be used in place of the impedance matching circuitry illustrated in FIG. 7. For example, the first inductor 18a may be omitted and the second inductor 18c may be a variable inductor whose inductance is controlled by voltage and/or current signals from the driving circuitry 20 (which is in turn controlled by the controller 16). In other examples, the impedance matching network 18 may comprise inductors, capacitors, couplings or any other means capable of compensating the antenna impedance mismatch. The impedance matching network 18 may be implemented in any suitable technology or technologies such as semiconductor, micro-electro-mechanical systems (MEMS), ferroelectric etc.

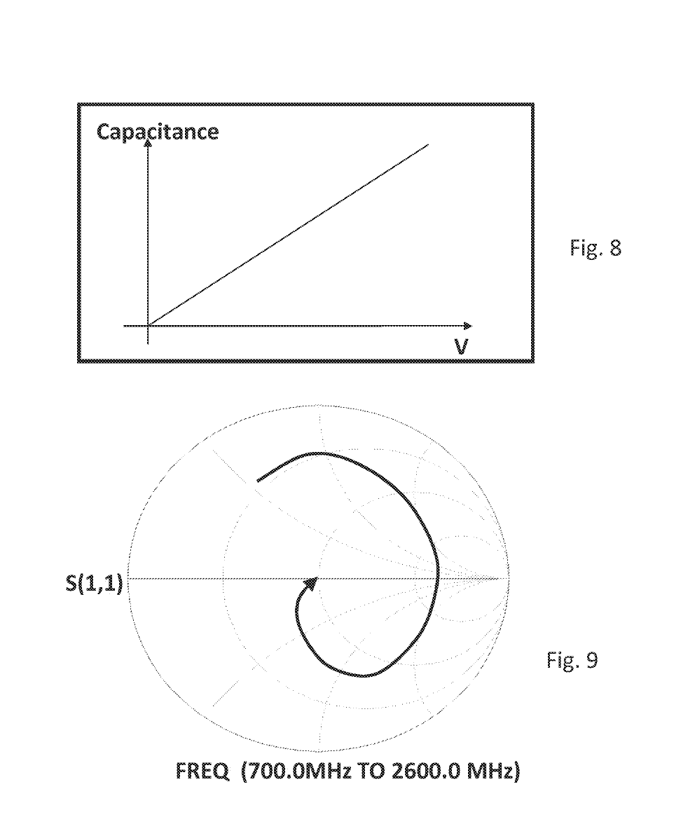

Preferably, one or more of the components in the impedance matching network 18 having a tuneable impedance is a tuneable MEMS capacitor (e.g. a tuneable MEMS capacitor described in international patent publication number WO2008/152428) which has capacitance which varies linearly (or substantially linearly) in response to a varying voltage (and/or current) control signal. This is illustrated most clearly in FIGS. 8a and 8b. FIG. 8a shows the linear capacitance response of the capacitor to a varying voltage control signal. As shown in the Smith chart of FIG. 8b, a linearly varying response of the tuneable MEMS capacitor allows a smooth transition from an impedance mismatch at the interface between the RF circuitry 2 and the antenna module 4 to an impedance match at the said interface. Otherwise, if instead of the continuous linear transition from an impedance mismatch to an impedance match there is (for example) a stepped transition, this can (at least temporarily) cause a significant mismatch to occur, which can lead to poor performance of the antenna (and, for example, dropped calls by the wireless communications device).

It may be that the impedance matching network comprises a bank of switched (typically MEMS) capacitors, which may be tuneable switched MEMS capacitors. A bank of switched capacitors typically provides a plurality of capacitors arranged in parallel and selectively connected together by way of respective switches. Each of the capacitors can be selectively activated by activating one or more respective switches to thereby change the impedance of the bank of switched capacitors. If the capacitors are themselves tuneable (i.e. if they have tuneable capacitances), a further degree of freedom is provided to control the combined impedance of the bank.

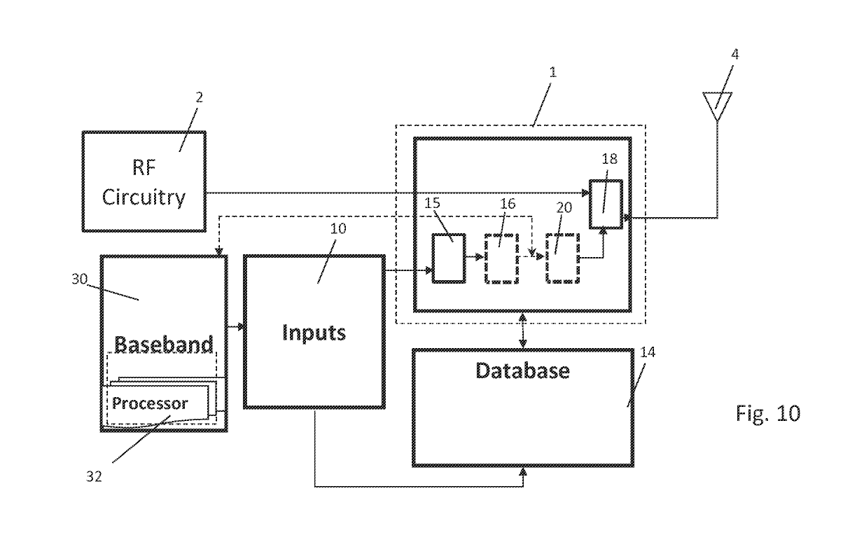

As shown in FIG. 10, the wireless communications device 5 comprises baseband circuitry 30 configured to manage one or more radio functions of (e.g. radio frequency transmissions from and/or radio frequency reception by) the wireless communications device 5. More specifically, the baseband circuitry comprises a baseband processor 32 which runs a software module configured to manage the said radio functions. In some embodiments, the controller 16 may comprise (or consist of, or at least employ) the baseband processor in a configuration in which it runs a software module for controlling the configuration of the impedance matching circuitry 18.

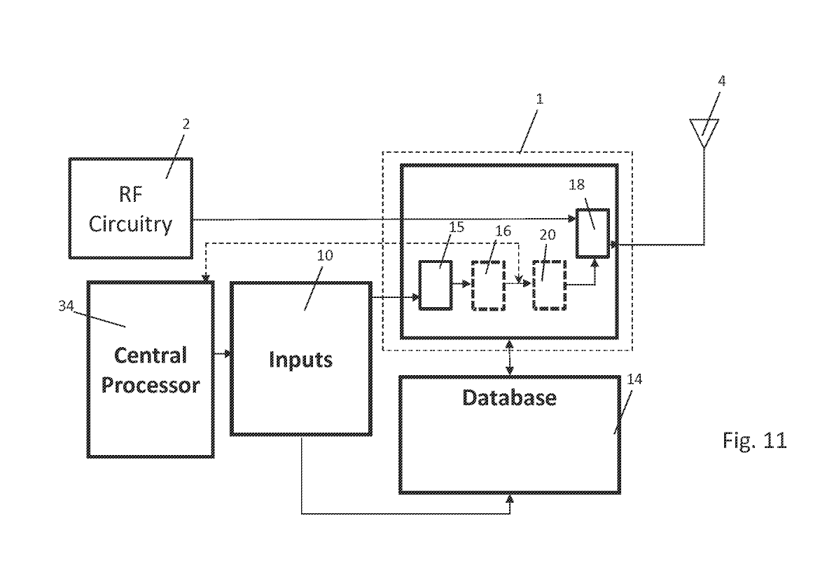

As shown in FIG. 11, the wireless communications device 5 further comprises a central processor 34 configured to run an operating system of the wireless communications device. In some embodiments, the controller 16 may comprise (or consist of, or at least employ) the central processor 34 in a configuration in which it runs a software module for controlling the configuration of the impedance matching circuitry 18.

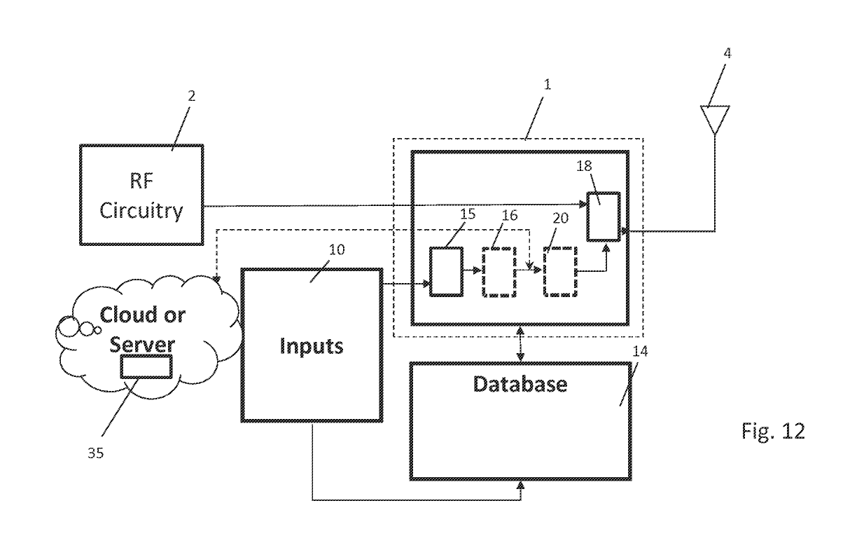

As shown in FIG. 12, the wireless communications device 5 is provided in wireless data communication with one or more server computers (“the cloud”) comprising one or more server computer processors. In some embodiments, the controller 16 may comprise (or consist of, or at least employ) one or more server computer processors 35 (with which the wireless communications device 5 is in wireless data communication) in a configuration in which it runs a software module for controlling the configuration of the impedance matching circuitry 18.

Alternatively, the controller 16 of the control system 12 may comprise a dedicated processor provided on the wireless communications device and configured to run a software module for controlling the configuration of the impedance matching circuitry 18. However, it is preferred to use the baseband processor or central processor of the wireless communications device 5, or one or more server computer processors of one or more server computers, to run the software module for controlling the configuration of the impedance matching circuitry 18 to make use of existing hardware rather than incurring the additional expense and footprint of providing a dedicated processor (e.g. on the wireless communications device).

As also shown in FIGS. 5-7, the controller 16 is configured to use inputs 10 and the database 14 to determine the configuration of the impedance matching circuitry 18.

As discussed, the impedance mismatch at the circuit interface between the RF circuitry 2 and the antenna module 4 is affected by a number of factors, such as the way in which a user holds or wears the device 5, the presence of a human body proximate the device 5, the location of the device and so on. As shown in FIG. 7, one way of correcting an impedance mismatch between the RF circuitry 2 and the antenna module 4 is to connect an impedance mismatch sensor 37 in a feedback loop from a position between the RF circuitry 2 and the antenna module 4 (typically from a position between the impedance matching circuitry 18 and the antenna module 4) to the controller 16. The controller 16 may then use impedance mismatch feedback provided by the impedance mismatch sensor 37 to reconfigure the impedance matching circuitry 18 until the impedance between the RF circuitry 2 and the antenna module 4 is matched. A disadvantage with this approach is that there is typically a lag between the detection of a mismatch by the mismatch sensor 37 and achieving an impedance match, during which the performance of the antenna module 4 may be compromised (and/or the power consumption of the antenna module 4 is significantly greater than required).

The impedance mismatch sensor may for example comprise one or more of the following: RF voltage detector (such as a diode detector, temperature compensated diode detector, logarithmic amplifier or any other means to detect an RF voltage magnitude), phase detector (such as one or more variable capacitor or any other means to detect an RF phase magnitude) or power detector (such as one or more directional coupler or any other means to detect an RF power).

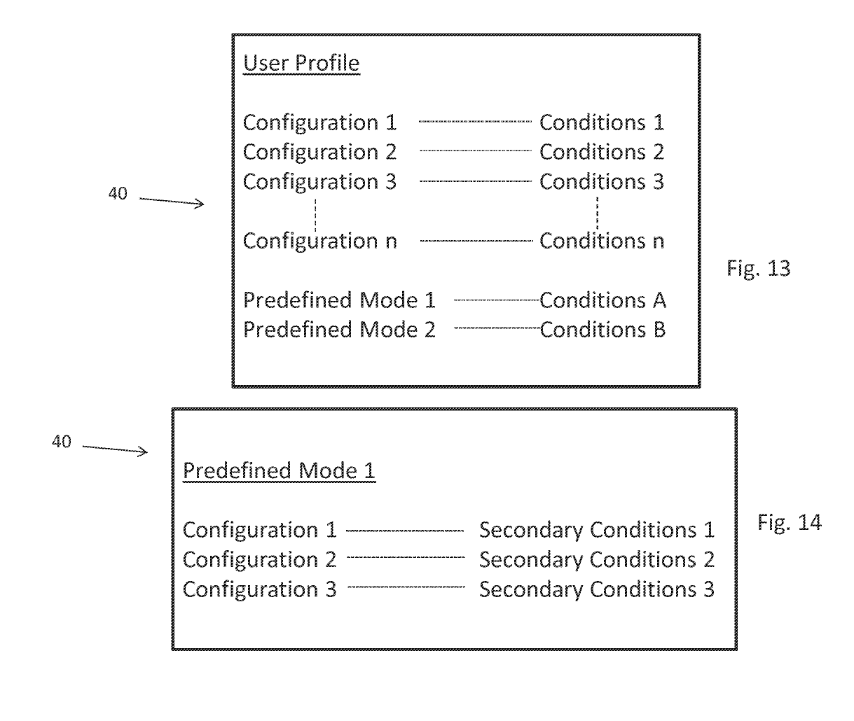

In order to speed up the process by which an impedance match is achieved between the RF circuitry 2 and the antenna module 4, database 14 is provided. The database 14 comprise a user profile 40 associated with the device or, more preferably, with a user of the device. As illustrated in FIG. 13, the user profile 40 comprises configuration data relating to a plurality of pre-set impedance matching circuitry configurations 1 to n, each of which is associated with one or more conditions. The conditions relate to one or more parameters which affect the impedance match between the RF circuitry 2 and the antenna module 4 (e.g. frequency conditions, location conditions, mode of use of wireless communications device 5). Each configuration is customised for the user associated with the user profile such that, when it is applied to the impedance matching circuitry under the conditions associated with that configuration, it provides an accurate impedance match between the RF circuitry 2 and the antenna module 4 (assuming that the user of the device 5 is the user associated with the user profile 40).

The configuration data relating to the pre-set configurations in the exemplary embodiment comprise voltage or current control signal values which can be applied to the driving circuitry 20 to adjust the impedance of one or more reactive components or one or more groups of reactive components provided in the impedance matching circuitry 18, to thereby adjust the impedance match at the circuit interface between the RF circuitry 2 and the antenna module 4.

Additionally or alternatively the impedance matching circuitry 18 may comprise a plurality of impedance matching networks which may be selectively connected between the RF circuitry 2 and the antenna module 4. In this case, the configuration data relating to the pre-set configurations of the user profile 40 may comprise an identifier for selecting one of a plurality of impedance matching networks of the impedance matching circuitry 18 to connect the RF circuitry 2 to the antenna module 4.

Additionally or alternatively the impedance matching may be partially or fully achieved by selecting a different antenna (or a different combination of antennae) from the antenna module 4 to perform a communications (e.g. transmitting or receiving) operation, or to adjust a physical characteristic (e.g. the length of) one or more antennae of the antenna module, to thereby adjust the impedance of the antenna module 4 as seen by the RF circuitry 2. In this case, the impedance matching circuitry 18 may comprise circuitry configured to select one or more antennae from a plurality of antennae of the of the antenna module 4 (thereby changing the impedance of the antenna seen by the RF circuitry 2) to perform a transmitting or receiving operation of the wireless communications device 5, or circuitry configured to adjust the said physical characteristic of the said one or more antennae as the case may be. In this case, the configuration data relating to the pre-set configurations may comprise configuration data for configuring the antenna module 4 such that the selected antenna(e) of the antenna module are used to perform the communications operation, or physical characteristic data for configuring the antenna(e) of the antenna module to achieve the required impedance of the antenna module 4 as seen by the RF circuitry 2.

The controller 16 is configured to use selected configuration data (i.e. configuration data relating to a selected one of the pre-set configurations 1 to n) to configure the impedance matching circuitry 18 responsive to a determination that one or more (or all) of the conditions associated with that configuration are or will be met. By providing configuration data relating to pre-set configurations which can be selected under appropriate circumstances, an impedance match can be achieved much more quickly than the purely iterative approach described above. Furthermore, as the pre-set configurations are customised for a particular user, a much more accurate impedance match can be achieved than if the configurations were universally designed for any user. This approach therefore significantly improves the performance and/or reduces the electrical power consumption of the antenna module 4 and associated RF circuitry 2.

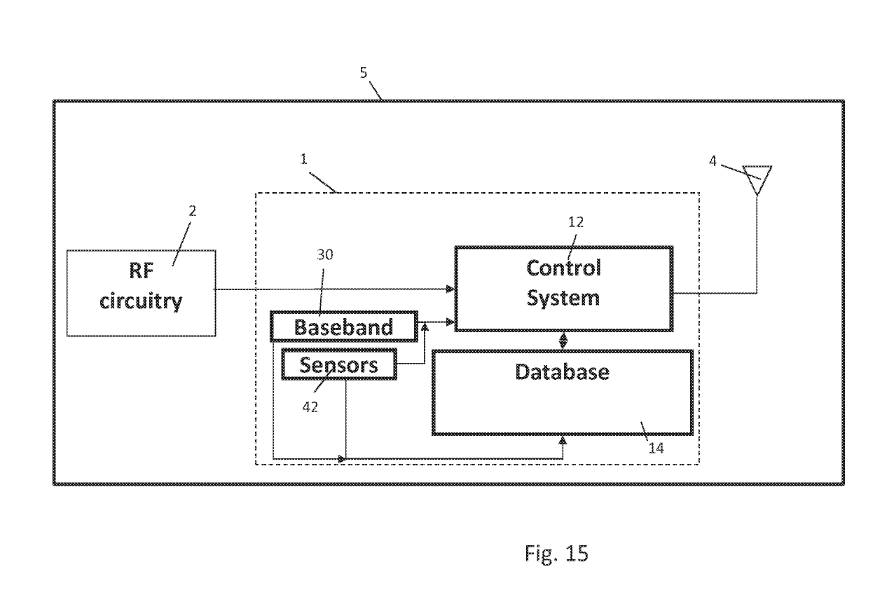

In order to determine whether the said conditions associated with a configuration are or will be met, the controller 16 is provided with inputs 10 by way of interface circuitry 12. The inputs 10 provide the controller 16 with information which the controller 16 can use to select the most appropriate pre-set configuration from the user profile 40 at any given time. For example, as shown in FIG. 15, the inputs 10 may comprise sensory inputs 42 from one or more sensors of the wireless communications device 5 provided in data communication with the controller 16 (e.g. through the central processor 34). The sensors of the wireless communications device 5 may be of any type able to provide information to the controller 16 which affects the impedance match at the circuit interface between the RF circuitry 2 and the antenna module 4. For example, the sensors may comprise any one or any combination of the following sensors:
a proximity sensor in data communication with the controller 16 (e.g. through the central processor 34 of the wireless communications device 5) and configured to provide the controller 16 with information as to whether any external objects (e.g. a user's head) are in close proximity to the wireless communications device 5; and/or
a voice sensor (e.g. microphone) in data communication with the controller 16 (e.g. through the central processor 34 of the wireless communications device 5) and configured to determine (and inform the controller 16) whether a user is speaking into the wireless communications device 5 (and thus whether the user is making a call);
a screen sensor in data communication with the controller 16 (e.g. through the central processor 34 of the wireless communications device 5) and configured to determine (and inform the controller 16) whether a screen of the wireless communications device is on or off (again this information may be used by the controller to determine that the user is making a call—e.g. if the voice sensor indicates that the user is speaking into the device and the screen is off, it may be deduced by the controller that the user is using the device to make a call);
a call mode sensor in data communication with the controller 16 (e.g. through the central processor 34 of the wireless communications device 5) and configured to determine (and to inform the controller) whether a telephone call is in progress on the wireless communications device;
an accelerometer (or other motion sensor) in data communication with the controller 16 (e.g. through the central processor 34 of the wireless communications device 5) and configured to detect (and provide to the controller an indication of) the orientation or movement of the device;
a compass in data communication with the controller 16 (e.g. through the central processor 34 of the wireless communications device 5) and configured to determine (and provide to the controller) an orientation of the device;
temperature and/or pressure and/or touch sensors in data communication with the controller 16 (e.g. through the central processor 34 of the wireless communications device 5) and configured to determine (and provide to the controller) one or more characteristics relating to the way in which the user is holding or wearing the wireless communications device;
touch sensors on a screen of the wireless communications device configured to determine one or more characteristics relating to one or more fingers of a user touching the screen (e.g. the positions on the screen of or the surface area of the screen covered by the user's fingers);
hardware configuration sensor in data communication with the controller 16 (e.g. through the central processor 34 of the wireless communications device 5) and configured to determine a hardware configuration of the wireless communications device and provide an indication of that hardware configuration to the controller (e.g. a “flip” style mobile phone or a mobile phone with a slidable keypad may comprise a first hardware portion moveable relative to a second hardware portion, and the hardware configuration sensor may be configured to inform the controller 16 of the position of the first hardware portion relative to the second hardware portion);
an ambient light sensor in data communication with the controller 16 (e.g. through the central processor 34 of the wireless communications device 5) and configured to determine an ambient light level in the environment of the device 5. The ambient light sensor is typically turned off when the wireless communications device 5 is in an idle mode, and the ambient light sensor is turned on when the wireless communications device 5 is active. Accordingly, simply be detecting whether the ambient light sensor is on or off the controller 16 can determine whether the device 5 is idle or active;
a (e.g. GPS) positioning module in data communication with the controller 16 (e.g. through the central processor 34 of the wireless communications device 5) and configured to estimate the position of the wireless communications device 5;
a headphones sensor configured to determine whether headphones are connected to the wireless communications device.

It will be understood that the sensors may be implemented in hardware, software or in a combination of hardware and software.

As also shown in FIG. 15, the inputs 10 include one or more inputs from the baseband circuitry 30. These inputs may provide frequency information relating to the frequency mode/band/channel on which the wireless communications device 5 is operating. The inputs from the baseband circuitry 30 may also provide information relating to the location of the device 5 (e.g. data relating to the locations of one or more wireless communications base stations with which the wireless communications device 5 is in data communication, and from which the location of the device 5 can be estimated).

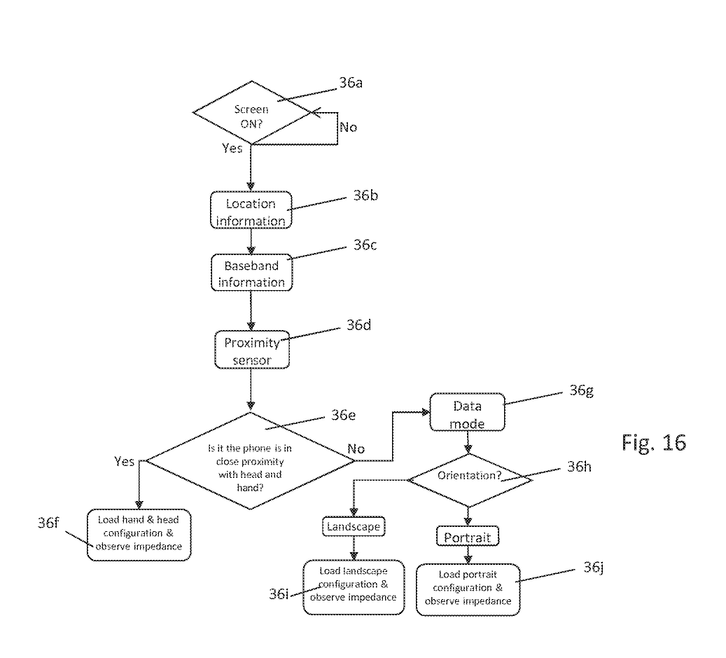

When a user makes a call from the wireless communications device 5, a number of changes occur which typically have a significant effect on the impedance match at the circuit interface between the RF circuitry 2 and the antenna module 4. For example, the way in which the user holds or wears the device changes, the frequency at which the wireless communications device communicates may change, a user's body may be brought into close proximity with the device and so on. Similar, but typically different, changes occur when a user uses the wireless communications device 5 to access data services (e.g. over a network). Accordingly, the controller 16 may be configured to determine from the inputs 10 if the user is using the device 5 to make a call or using the device 5 to access data services, and use selected configuration data, or a selected sequence of configuration data, from the user profile 40 to configure the impedance matching circuitry 18 responsive to that determination. This process is illustrated in FIG. 16.

In a first step 36a, the controller 16 is configured to determine whether the screen of the wireless communications device is on. If the screen is off, no action is taken and the controller 16 remains in a checking loop until it detects that the screen is on. In a next step 36b, the controller 16 obtains location information, typically from a positioning (e.g. GPS) module. The controller 16 is further configured to obtain frequency and location information from the baseband circuitry in a next step 36c. Next, in step 36d, a check is performed to monitor a proximity sensor of the device 16. If the controller 16 determines in step 36e that the device is in close proximity with both the head and hand of the user (e.g. using data from the proximity sensor, and optionally using data from one or more touch/pressure/temperature sensors in communication with an external surface of the device 5), it deduces in a next step 36f that the user is using the device 5 to make a call and selects and uses selected configuration data (and optionally a sequence of selected configuration data) from the user profile to configure the impedance matching circuitry 18. Alternatively if the controller 16 determines that the device 5 is not in close proximity with both the head and hand of the user it deduces in a next step 36g that the device 5 is being used in data mode. In this case, a further check may be performed in step 36h to determine the orientation of the device. The controller 16 may then use different selected configuration data (and optionally a different sequence of selected configuration data) from the user profile to configure the impedance matching circuitry 18 depending on whether the device is in landscape or portrait orientations in alternative steps 36i, 36j.

The configuration data of the user profile is customised for a user of the device (typically a user associated with the user profile). In the case of the user making a call or using the device in data mode, the customisation includes (for example) taking into account the user's preferred way of holding or wearing the wireless communication device in that mode, the effects of the proximity of that user's body (e.g. hands and/or head) on the (input or output) impedance of the antenna module 4 as seen by the RF circuitry 2 and so on.

It may be that configuration data relating to a plurality of different configurations are provided in the user profile, each different configuration relating to different ways in which the user holds or wears the wireless communications device. In this case, rather than presuming that the user is holding or wearing the wireless communications device 5 in a preferred way, the controller 16 may be configured to take into account signals from one or more temperature and/or pressure and/or touch sensors of the device to determine one or more characteristics regarding how the user is holding or wearing the device 5 (e.g. finger position, surface area of the casing and/or antenna covered by user's hand) and to select configuration data relating to one of the said pre-set configurations, or a sequence of pre-set configurations, from the user profile 40 responsive to that determination. In this case, each of the said selected configurations is typically associated with a condition in the user profile 40 relating to that characteristic.

The controller 16 is configured to receive sensory inputs from two or more sensors of the wireless communications device 5 and is preferably configured to use selected configuration data associated with one of the pre-set configurations (or with a sequence of pre-set configurations) from the user profile 40 to configure the impedance matching circuitry 18 responsive to a determination that conditions relating to two or more sensors of the wireless communications device (and associated with that/those configurations) are or will be met. For example, the controller 16 may receive an input from a first sensor (e.g. a voice sensor) indicating that the user is speaking into the wireless communications device 5. This may be an indication that the user is using voice recognition software on the device, but it may also be an indication that the user is making a call. An impedance mismatch at the circuit interface between the RF circuitry 2 and the antenna module 4 may be significantly different when the user is making a call as compared to when the user is using voice recognition software (e.g. because the user holds or wears the device 5 in different ways in each case and/or because the user's head is at a different position relative to the device in each case). By taking into account signals from a second sensor, such as a screen sensor which indicates that a screen of the device 5 is off, or a proximity sensor which indicates that an object is in close proximity to the device 5, or an orientation sensor (e.g. compass) which indicates a particular orientation of the device 5, the controller 16 may determine with a greater degree of certainty that the user is making a call on the device rather than using voice recognition software (or vice versa) and to select and use selected configuration data from the user profile 40 to apply one of the pre-set configurations to the impedance matching circuitry accordingly. It will be understood that the conditions associated with the configuration data may also be customised for the user associated with the user profile.

A plurality of different configuration data sets may be provided in the user profile 40, each relating to different positions of the wireless communications device. Each of the said configuration data sets in the user profile 40 may be associated with one or more location conditions specifying that the device 5 occupies a particular position or locus. The controller 16 may be configured to determine (e.g. from a GPS positioning module or the baseband circuitry 30—see below) that the position of the device 5 matches the position or locus associated with a configuration data set of the user profile, and to select that configuration data set and use it to configure the impedance matching circuitry 18.

As also shown in FIG. 15, the inputs 10 may also include data received from the baseband circuitry 30. For example, the baseband circuitry 30 may be configured to provide the controller 16 with radio frequency information relating to a frequency of communication of the wireless communications device 5. The radio frequency information may comprise a frequency mode of operation of the device 5 (e.g. whether it is communicating using 2G, 2.5G, 3G, LTE or 4G mobile telecommunications standards), a frequency band of operation or information identifying a frequency channel on which the device 5 is communicating. The configuration data in the user profile 40 may be associated with one or more respective frequency conditions relating to the frequency at which the device 5 is communicating. Accordingly, the controller 16 may be programmed to select configuration data from the user profile 40 which is associated with the radio frequency at which the wireless communications device 5 is communicating and apply it to the impedance matching circuitry 18.

Location information relating to the location of the wireless communications device 5 may also be obtained from the baseband circuitry 30 (either in addition to or as an alternative to location information provided by a positioning module, where provided). For example, the baseband circuitry 30 may provide information regarding the nearest (and neighbouring) mobile base stations to the wireless communications device 5, and this information can be used by the controller 16 to estimate a position of the device 5. Alternatively, the baseband circuitry 30 may estimate the position of the device 5 using this data and provide an estimate of the position of the device to the controller 16. As discussed above, this location information can be used by the controller 16 to select and apply appropriate impedance matching configurations from the user profile 40 to the impedance matching circuitry 18.

The wireless communications device 5 typically comprises a clock configured to determine the time of day and/or day of the week and in data communication with the controller 16 (e.g. through the central processor 30). The conditions associated with one or more configurations in the user profile may comprise one or more time conditions. A time condition may specify a time of day and/or one or more days of the week at which a particular configuration may be selected by the controller 16 and applied to the impedance matching circuitry. Time conditions (where provided) are typically associated with one or more patterns of usage of the device 5 by the user. It may be that a consistent impedance mismatch occurs at the circuit interface between the RF circuitry 2 and the antenna module 4 at particular times of day and/or days of the week, and the controller 16 may be configured to use selected configuration data to configure the impedance matching circuitry 18 at those times and/or days of the week to achieve an impedance match.

It will be understood that, typically, the more conditions associated with a particular impedance matching configuration in the user profile 40, and the more conditions associated with an impedance matching configuration that are determined to have been met (and/or the more conditions in respect of which determinations have been made that they will be met) before selecting and applying that configuration, the more accurate the impedance match that is achieved at the circuit interface between the RF circuitry 2 and the antenna module 4. It will be understood therefore that preferably a plurality of conditions associated with selected configuration data of the user profile 40 are typically required to be met before the controller 16 will select and apply that impedance matching configuration to the impedance matching circuitry 18.

It will be appreciated that different makes/models of wireless communications device 5 will have different impedance matching characteristics. For example, if a user holds or wears two different devices the same way, there may be a significant difference between the impedance mismatches caused by the user's interaction with the device. Accordingly, it is preferred that the configuration data of the user profile 40 are customised for the hardware configuration (e.g. make/model) of the wireless communication device 5.

Configuration data may be grouped together in the user profile as part of a predefined mode relating to a usage pattern of the device 5 (e.g. by the user associated with the user profile). This is illustrated in FIG. 14. The predefined mode is a mode of the controller 16 defined by predefined mode data provided by the user profile. A predefined mode may comprise a location track which relates to a commonly followed route/journey by the device 5, such as the journey between home and work for a user of the device 5. The configuration data provided as part of the predefined mode provide suitable impedance matches at the circuit interface between the RF circuitry 3 and the antenna module 4 along the route/journey. In another example, a predefined mode may be provided which relates to an operation of the wireless communications device 5, such as making a call or accessing data services (e.g. via the internet). In this case the configuration data provided as part of the predefined mode provides suitable impedance matches between the RF circuitry 2 and the antenna module 4 during the process of setting up and making the call or during the process of accessing data services and observing delivered content (as the case may be), for example taking into account ways in which the user holds or wears the device 5 during these processes.

A predefined mode may be associated with one or more predefined mode conditions which must be met (or a determination must be made that the said predefined mode conditions will be met) for the controller 16 to enter the predefined mode. For example, the predefined mode conditions may specify that the device 5 is at (or approaching) a position or locus on the route. Additionally or alternatively a predefined mode condition may specify that the device occupies two or more subsequent or consecutive positions or loci along the route. Additionally or alternatively a predefined mode condition may specify one or more sensor conditions relating to the making of a call or the accessing of data services by a user.

Once the controller 16 has entered the predefined mode, the configuration data within the predefined mode is typically associated with one or more secondary conditions which must be met (or a determination must be met by the controller 16 that the conditions will be met) for the controller 16 to select and use that selected configuration data to configure the impedance matching circuitry 18. Typically the configuration data comprises a plurality of configuration data sets, each configuration data set being associated with one or more respective secondary conditions. A configuration data set is selected from the plurality of configuration data sets responsive to a determination that the secondary condition(s) associated with that data set are met.

A secondary condition may specify a more accurate position or locus along a route associated with the predefined mode, for example, than a locus specified by the predefined mode condition. Additionally or alternatively the secondary conditions may comprise any one or any combination of the conditions described above (e.g. time conditions, orientation conditions relating to the orientation of the device 5, frequency conditions relating to the frequency of communication of the device 5 and so on) or indeed any other suitable condition(s). The controller 16 is typically configured, in a predefined mode, to use a selected configuration data set to the impedance matching circuitry 18 responsive to a determination that one or more (preferably two or more or all of the) secondary conditions associated with that configuration data set are or will be met.

When the controller 16 is in a predefined mode, testing may be performed by the controller 16 to determine whether the controller 16 should remain in that mode. For example, the controller 16 may be configured to test whether the predefined mode conditions associated with that predefined mode are still or will still be met. However, it may be the case that tests as to whether the controller 16 should remain in a particular predefined mode are performed less frequently than tests as to whether the secondary conditions associated with the impedance matching configurations of the user profile are (or will be) met until, for example, an event occurs (e.g. the device approaches a position not on the route).

The frequency with which the controller 16 tests whether predefined mode conditions are met may increase as the device approaches a position or locus associated with the predefined mode.

In some embodiments, the controller 16 is configured to use the predefined mode data in the user profile 40 to predict a change in one or more parameters, and to use selected configuration data from the user profile 40 to configure the impedance matching circuitry 18 responsive to that predicted change. Such a prediction may be made in response to sensory data 42 input to the controller 16 from one or more sensors of the device 5. For example, as discussed above, the controller 16 may be configured to predict from sensory data 42 that the device 5 is going to be used to make a call (e.g. from data received from a voice sensor, orientation sensors, proximity sensors and so on). It may be that the controller 16 is configured to access data relating to a predefined mode in the user profile responsive to a determination that the controller has entered or will enter that predefined mode and proactively use selected configuration data from that predefined mode to configure the impedance matching circuitry 18 responsive to that determination.

In another example, the controller 16 may be configured to predict a future position or locus of the device 5 (and thus a radio frequency of communication it may switch to) based on information such as the direction of travel of the device 5 (which may be determined using GPS, or orientation data from a compass on the device 5), speed of movement of the device and so on. The controller 16 may be configured to use selected configuration data from the user profile 40 to apply a new impedance matching configuration to the impedance matching circuitry 18 responsive to such a prediction, for example by using configuration data associated with the predicted position or locus of the device 5 to configure the impedance matching circuitry 18 before the controller 16 has determined (e.g. from a GPS positioning module) that the device 5 has reached that position.

Additionally or alternatively, the controller 16 may be configured to use first selected configuration data associated with the predicted position or locus of the device to configure the impedance matching circuitry responsive to said prediction, and to then use second selected configuration data associated with the predicted position of the device to configure the impedance matching circuitry responsive to confirmation that the device 5 has reached the said position or locus. In this case, the second selected configuration data is typically stored in fast memory whilst the first configuration is being applied. The second selected configuration data provides a more accurate impedance match in the event that the predicted parameter change occurs than the first selected configuration data, but the first selected configuration data provides a more accurate impedance match in the event that the said parameter remains constant (as opposed to changing as predicted) than the second selected configuration data. The first selected configuration data provides a more accurate impedance match in the event that the predicted parameter change occurs than the impedance matching configuration of the impedance matching circuitry 18 immediately prior to that derived from the first selected configuration data. Accordingly, it will be understood that the first selected configuration data is designed to anticipate the occurrence of an impedance mismatch, but does not commit fully to correcting the mismatch before it occurs in case the parameter change fails to materialise as expected.

By anticipating impedance mismatches and compensating for them proactively (i.e. either partially or fully compensating for the mismatch before confirmation has been obtained that the mismatch has occurred) in this way, a more accurate impedance match can be achieved much more quickly than in purely reactive systems.

Additionally or alternatively, the controller 16 may be configured to select the configuration data associated with the predicted position of the device and to copy the selected configuration data into fast memory. The controller 16 may be configured to use the selected configuration data to configure the impedance matching circuitry 18 responsive to a determination (e.g. from the baseband circuitry or from a GPS module) that the device 5 has indeed reached the predicted location.

It will be understood that when the device 5 moves positions, a different impedance matching configuration may become more optimal than an existing configuration. Accordingly, the controller 16 is typically configured to determine whether new configuration data should be selected and applied to the impedance matching circuitry responsive to a determination that the device 5 has moved. Motion sensors (e.g. an accelerometer) of the wireless communications device 5 can provide motion data to the controller 16 from which it can be determined whether the device 5 is moving or not. This also applies to configuration data sets within a predefined mode. That is, the controller 16 may enter a predefined mode responsive to a determination that the device 5 occupies a position on a route associated with the predefined mode. In so doing, the controller 16 uses first selected configuration data to configure the impedance matching circuitry 18. It may be that the controller 16 does not then update the configuration of the impedance matching circuitry 18 until a determination is made that the device has changed positions from motion sensor signals detected by the controller 16.

The controller 16 may be further configured to monitor a position (or a change in position) of the wireless communications device 5 (e.g. using one or more positioning modules), to predict a change in the impedance match at the interface responsive to a detected position of the wireless communications device 5 and to adjust the impedance matching configuration of the impedance matching circuitry 18 in accordance with said predicted change (i.e. so as to improve the impedance match at the interface when the said predicted change occurs). For example, it may be determined from the detected position (or from two or more, e.g. subsequent or consecutive, detected positions) of the device 5 that it is approaching a position or locus where the impedance match at the circuit interface typically changes. The said prediction is typically based on information obtained from (e.g. a predefined mode of) the user profile.

As discussed above and as shown in FIG. 7, the control system 12 may comprise an impedance mismatch sensor 37 in a feedback loop from a position between the RF circuitry 2 and the antenna 4 to the controller 16. It may be that that the controller 16 is configured to use configuration data from the user profile 40 to configure the impedance matching circuitry 18, but also to then refine that impedance matching configuration (if necessary) using feedback from the impedance mismatch sensor 37.

The controller 16 may further comprise a learning mode in which it is configured to determine or refine impedance matching configurations applied to the impedance matching circuitry 18 and store configuration data relating to the determined or refined impedance matching configurations in the user profile 40. In this case, the controller 16 uses feedback from the impedance mismatch sensor 37 to determine whether the impedance match at the interface is acceptable. If the controller 16 determines that the impedance match at the interface is not acceptable, the controller 16 adjusts the impedance matching configuration of the impedance matching circuitry 18. This process is repeated until an acceptable impedance match is achieved, and the configuration data relating to the configuration of the impedance matching circuitry 18 when the acceptable impedance match is achieved is stored by the controller 16 in the user profile. The controller 16 may be further configured to determine one or more parameters and/or one or more conditions associated with the determined or refined impedance matching configurations and to store them in the user profile 40 (and to associate it with the said configuration data). For example, the controller 16 may be configured to record data from one or more sensors of the wireless communications device against the determined or refined configuration data (or data derived therefrom). Accordingly, as illustrated in FIGS. 5-7, the inputs 10 are typically provided in data communication with the database 14 such that the said conditions can be recorded against the determined or refined configuration data.

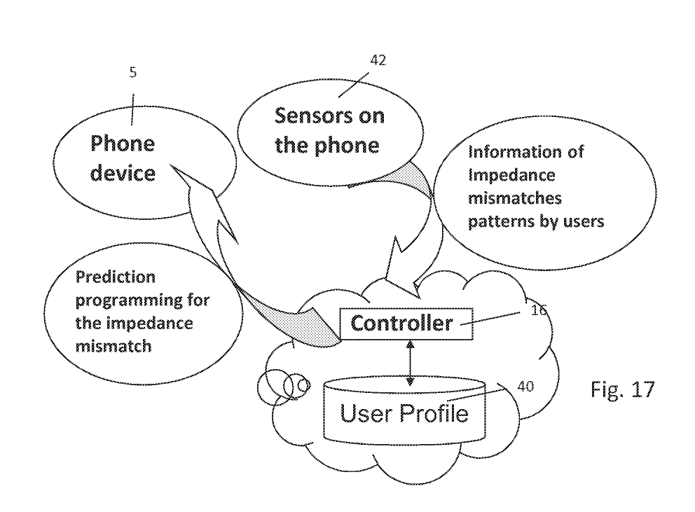

The controller 16 may be configurable to record one or more predefined modes in the user profile 40 by storing configuration data relating to a plurality of subsequent (typically consecutive) impedance matching configurations and their respective sensor conditions in the user profile 40. This configuration data can be accessed (and optionally refined) by the controller 16 later to match the impedance at the circuit interface between the RF circuitry 2 and the antenna module 4. This is illustrated by FIG. 17.

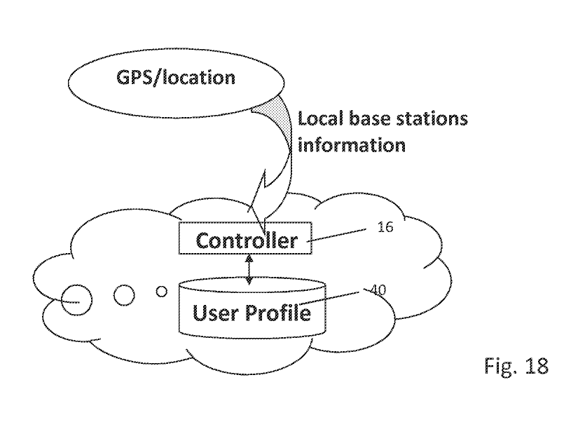

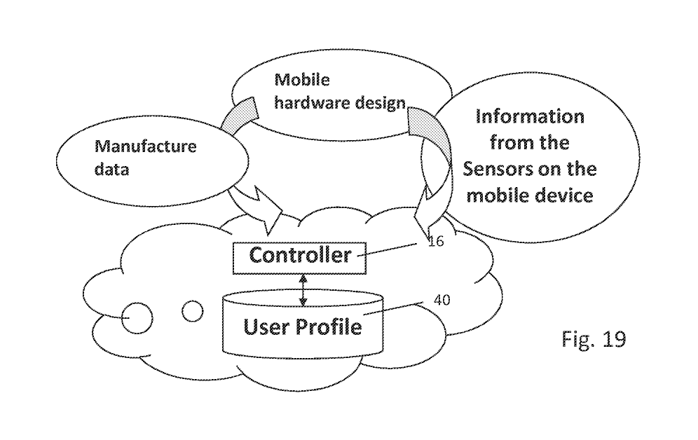

It will be understood that, as shown in FIG. 18, location information relating to a position of the device 5 may also be obtained (e.g. from a GPS module or from the baseband circuitry 30) and stored by the controller 16 in the user profile 40 as a location condition against the configuration data relating to the determined impedance matching configuration(s) of the device 5 at that location. As shown in FIG. 19, hardware data relating to the hardware design of the wireless communications device (e.g. make/model) may also be stored in the user profile 40 as a hardware condition associated with the configuration data relating to the impedance matching configurations determined using that device.

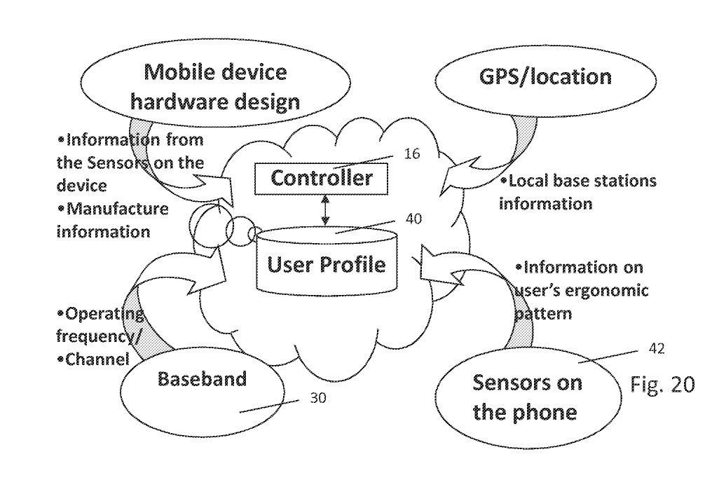

As shown in FIG. 20, frequency data (e.g. from the baseband circuitry 30) relating to the frequency mode/band/channel of operation of the device 5 when a particular configuration was determined or refined may also be stored in the user profile 40 as a frequency condition associated with that configuration data. As also shown in FIG. 20, data relating to the way in which the user holds or wears the device (e.g. surface area of antenna covered, finger position) may also be determined and stored by the controller 16 in the user profile as a sensor condition associated with configuration data of the user profile specifying the way in which the user held or wore the device 5 when the impedance matching configuration was determined or refined. The said data relating to the way in which the user holds or wears the device 5 may be determined from one or more touch/pressure/temperature sensors provided in or on the wireless communications device 5.

It is noted that the configuration data of the user profile 40 may additionally or alternatively comprise one or more functions having one or more parameters of the device (which parameters typically affect the impedance match between the circuitry 2 and the antenna module 4) as variables. The functions can then be used together with determined parameters of the device to configure the impedance matching circuitry accordingly to thereby achieve an impedance match between the RF circuitry 2 and the antenna module 4.

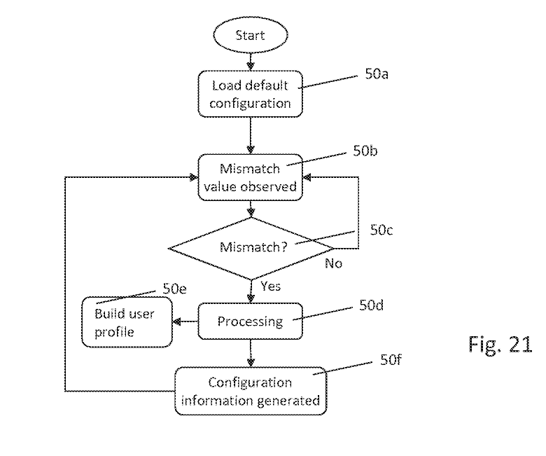

FIGS. 21 to 24 are flow diagrams illustrating ways in which impedance matching may be achieved while building the user profile. More specifically, FIG. 21 illustrates an initial situation in which no usage data relating to usage of the device (whether by the user or otherwise) is stored in the user profile. In this case a generic user profile may be provided comprising a plurality of default impedance matching configurations associated with respective conditions. The default impedance matching configurations may be customised for the hardware design (e.g. make/model) of the wireless communications device. When one or more (or two or more or all) of the conditions associated with a default configuration are met, the controller 16 applies that default configuration to the impedance matching circuitry 18 in a first step 50a. The impedance mismatch sensor 37 is configured to observe the impedance match between the RF circuitry 2 and the antenna module 4 in a next step 50b, and to feed back impedance mismatch data to the controller 16 indicative of any observed mismatch in a next step 50c. The controller 16 is configured to then refine (customise) the default configuration applied to the impedance matching circuitry 18 for the user if necessary in a next step 50d. The controller 16 is then configured to both store configuration data specifying the refined (customised) configuration in the user profile in step 50e (typically together with one or more parameters, such as location of the device 5, data derived from one or more sensors, frequency/location data from the baseband when the refined configuration was determined and/or one or more conditions relating to such parameters) and to apply that configuration to the impedance matching circuitry 18 in step 50f. Alternatively, the configuration/conditions in the user profile 40 may be iteratively updated by the controller 16. It may be that the controller 16 does not perform step 50e until an acceptable impedance match is achieved.

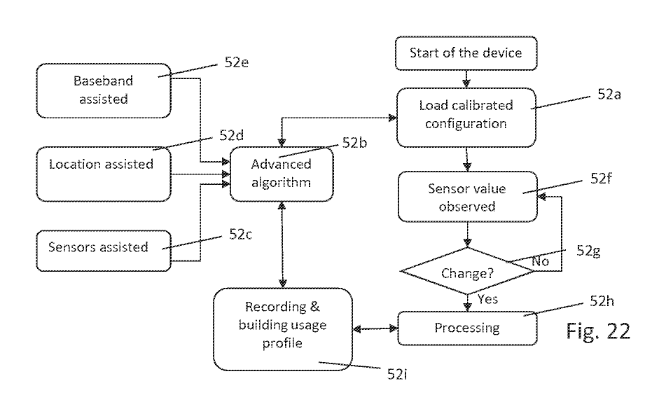

FIG. 22 shows an algorithm which may be applied by the controller 16, wherein the inputs 10 are used to build the user profile and to select appropriate configuration data from the user profile 40 to configure the impedance matching circuitry 18 at any given time. In a first step 52a, configuration data is selected by the controller 16 from the user profile 40 and used to configure the impedance matching circuitry 18 responsive to a determination by the controller 16 that one or more (or two or more or all) of the conditions associated with that configuration in the user profile are or will be met. The determination that one or more (or two or more or all) of the conditions associated with that configuration data in the user profile are or will be met is performed by the controller 16 in step 52b taking into account sensor data 52c, location data (e.g. from a positioning module or from the baseband circuitry) 52d and baseband data 52e (e.g. location or radio frequency data from the baseband circuitry 30). In a next step 52f, the controller is configured to observe mismatch data from the impedance mismatch sensor 37 until a change in one or more parameters affecting the impedance match at the circuit interface between the RF circuitry 2 and the antenna module 4 is observed. When such a change is observed, different configuration data may be selected from the user profile and used to configure the impedance matching circuitry 18 to improve the impedance match at the circuit interface between the RF circuitry 2 and the antenna module 4 in step 52g. Additionally or alternatively, a refined impedance matching configuration may be iteratively determined by the controller 16 responsive to impedance mismatch data provided by the impedance mismatch sensor 37 in step 52h. In this case, the controller 16 is configured to update (customise or further customise) the user profile in step 52i by storing configuration data specifying the refined impedance matching configuration (typically together with one or more parameters of the device and/or one or more conditions relating to such parameters) in the user profile 40. The configuration data relating to the refined configurations can then be used under similar circumstances by the controller 16 later to achieve an accurate impedance match more quickly.

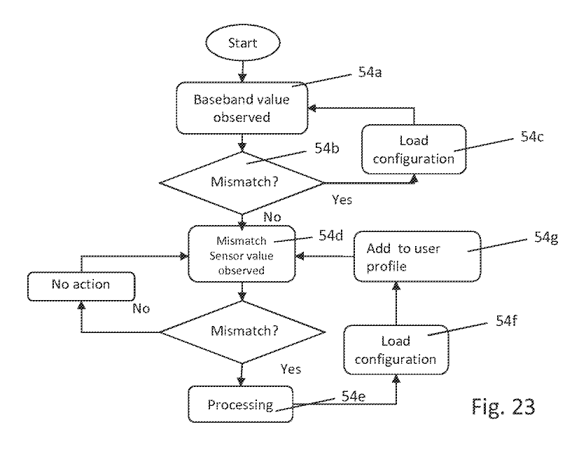

FIG. 23 illustrates an algorithm which may be employed by the controller 16 which uses inputs 10 from the baseband circuitry 30 and not the inputs 10 from the sensors of the wireless communications device to select the configuration data to use to configure the impedance matching circuitry 18. In a first step 54a the frequency (mode and/or channel and/or band) of communication of the antenna module 4 is obtained by the controller 16 from the baseband circuitry 30. In a second step 54b, the impedance mismatch sensor 37 determines whether there is an impedance mismatch at the circuit interface between the RF circuitry 2 and the antenna module 4. If there is a mismatch, configuration data relating to a different impedance matching configuration may be selected from the user profile 40 and used to configure the impedance matching circuitry 18 in a next step 54c responsive to a determination that the frequency value obtained from the baseband circuitry 30 matches a frequency condition associated with that configuration in the user profile 40. This process is repeated until there is an acceptable impedance match at the circuit interface between the RF circuitry 2 and the antenna module 4. The “acceptable impedance match” in this case may be an approximate impedance match where the impedances being matched is matched to within a first acceptable mismatch range.

In a next step 54d, feedback is provided by the impedance mismatch sensor 37 to the controller 16 to determine the extent of the impedance match achieved by the configuration from the user profile 40. If the impedances are matched to within a second predefined acceptable mismatch range (which is more accurate than the first predefined acceptable mismatch range), no action is taken to change the impedance matching configuration of the impedance matching circuitry 18. The controller 16 continues to check that the impedances are matched to within the second predefined acceptable mismatch range until they are no longer so matched. When the controller 16 determines that the impedances are no longer so matched (or were not so matched), the controller 16 is configured to iteratively adjust the impedance matching configuration of the impedance matching circuitry in next steps 54e, 54f until the impedances match to within the second range. Configuration data relating to the refined configuration is then stored in the user profile 40 in step 54g together with baseband configuration data relevant to when the new or refined configuration was determined.

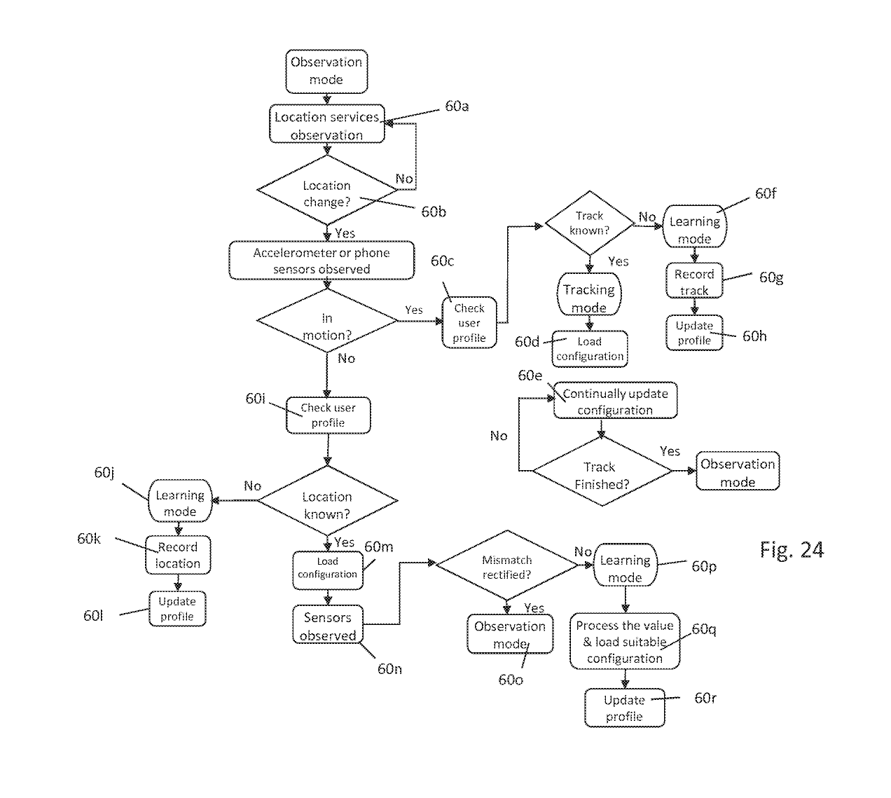

FIG. 24 is a flow chart illustrating an algorithm which may be employed by the controller 16 to determine whether the device 5 is following a location track associated with a known predefined mode, and to record new (or refined) location track in the user profile 40 relating to a new route followed by the device 5 (i.e. a route not previously known by the user profile 40). In a first step 60a, the location of the device 5 is observed until a location change is detected. Additionally (or alternatively) in step 60b, a location change may be detected from data received or derived from one or more motion sensors (e.g. a 2D or 3D accelerometer) of the device 5. If the device 5 is in motion, the user profile associated with that device 5 (or with the user of the device 5) is checked in step 60c to determine if the predefined mode conditions associated with a predefined mode (location track) stored in the user profile are met. If the predefined profile conditions are met, the controller 16 enters tracking mode and configuration data from that predefined mode (location track) are used to configure the impedance matching circuitry 18 when their secondary conditions are met (as discussed above) in steps 60d and 60e until the track is finished when the controller re-enters observation mode. If the predefined conditions associated with none of the predefined modes (location tracks) are met, the controller 16 may enter learning mode in step 60f as described above to determine in step 60g and record in the user profile 40 in step 60h configuration data specifying two or more subsequent (or consecutive) impedance matching configurations which provide an accurate impedance match under certain conditions. As discussed above, the controller 16 is also typically configured to record (secondary) conditions (and/or parameters) associated with the determined configurations in the user profile 40.

Referring back to step 60b, if the controller 16 determines that the device 5 is not in motion, it may proceed in step 60i to check whether any configuration data is provided in the user profile associated with the current location of the device 5. If not, the controller proceeds in step 60j to enter learning mode to determine an appropriate impedance matching configuration and store configuration data specifying that configuration (typically together with a location condition) in the user profile in steps 60k and 60l. On the other hand, if there is configuration data in the user profile 40 associated with that location, that configuration may instead be selected and used by the controller 16 to configure the impedance matching circuitry 18 in step 60m. Next, the impedance matching sensor 37 provides impedance mismatch data to the controller 16 in step 60n. If there is an impedance match, the controller 16 reverts to an observation mode in step 60o in which it checks for a location change of the device 5 in a loop as discussed above. If there is not an impedance match, the controller 16 enters learning mode in step 60p in which a new impedance matching configuration is determined as discussed above, applied to the impedance matching configuration in step 60q and configuration data specifying that configuration is stored in the user profile 40 in step 60r (typically together with one or more conditions, typically including a location condition).

It will be understood that, for a condition to be met (or for a determination to be made that a condition will be met), it is not necessarily the case that a condition must be met precisely. For example, it may be that a determination is made that a condition is met if it is determined that a parameter lies within a predefined range of a parameter value specified by the said condition. Similarly, it will be understood that for an impedance match to be detected, it is not necessarily the case that an absolute match between the impedances being matched must be achieved. Rather, a predefined range is typically defined which permits the impedances to be different to a predefined degree while still permitting a determination to be made that a match has been achieved.

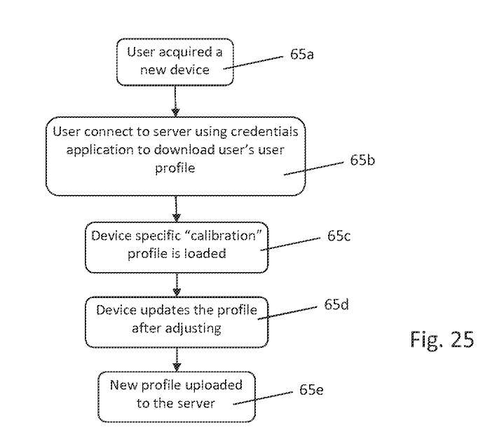

FIG. 25 is a flow chart illustrating an algorithm which may be followed in order to update a user profile in the event that a user associated with the user profile acquires or begins using a new wireless communications device. In this case, it is assumed that the user profile 40 is stored in the memory of a server computer in communication with (or comprising) the controller 16. In a first step 65a, the user acquires a new wireless communications device 5. In a second step 65b, the user connects to the server to download their user profile 40 to the new device 5 from the server and loads device specific calibration data relating to their new device (or alternatively the user uploads the device specific calibration data relating to their new device 5 to the server). In a next step 65c configuration data in the user profile is adjusted in accordance with the calibration data to take into account differences (e.g. in the hardware design, functionality and/or configuration) of the new device 5 versus a device 5 previously associated with the user profile 40. In a next step 65d, the adjusted user profile is stored on the memory (e.g. of the server in this case). In this way, the performance of the antenna module 4 of the new wireless communications device 5 can be improved without having to re-learn impedance matching configurations and predefined modes from scratch (although it will be appreciated that some refinement in learning mode is typically required). In a final step 65e the new user profile may be uploaded to the server.

It will be understood that for a new user having no customised user profile to inherit from use with a previous device, an initial, generic user profile may be provided which can be customised as the user begins to use the device. In this case, it may be that the generic user profile is calibrated taking into account properties (e.g. the hardware design, functionality and/or configuration) of the device, typically before any personal customisation is performed on the profile.

In some embodiments, third party location information may be used to provide positioning information relating to the position of the device, for example to determine a current position of the device and/or to determine historical positioning data relating to historical positions of the device (and thus the user). For example, third party mapping software (e.g. Google maps or similar) which keeps track of the position of a wireless communications device, and in some cases stores a history of locations of the device, may be used by the controller (in which case the controller is typically provided in communication with the third party location information source). Current location data (relating to a current position of the wireless communications device) from such a third party source may be used, for example, to determine whether a predefined mode should be entered, or to determine whether one or more location conditions have been (or will be) met. Historical positioning data from such a third party source may be used to help determine one or more of the said predefined modes (e.g. location paths), for example to help provide a level of customisation to an initially generic user profile for the user. Fine tuning/personal customisation of the predefined modes is typically then performed as discussed to increase the accuracy of the predefined modes for that user (e.g. to account for different hand/head effects etc).

It will be understood that a plurality of user profiles may be provided in the memory, each of the said plurality of user profiles being associated with a different user of the wireless communications device. In this case, the controller 16 may be configured to determine the identity of the user of the wireless communications device (e.g. from a log-in procedure) and to use data from that user's user profile to configure the impedance matching circuitry.

Further variations and modifications may be made within the scope of the invention herein described.

1. Wireless communications apparatus comprising:
a wireless communications device comprising: an antenna module; circuitry in communication with the antenna module; a circuit interface within the circuitry or between the circuitry and the antenna module; and impedance matching circuitry configurable to adjust an impedance match at the circuit interface; and
a controller in data communication with a memory storing a user profile associated with the wireless communications device, or with a user of the wireless communications device, the user profile comprising configuration data relating to one or more impedance matching configurations of the impedance matching circuitry, the configuration data being associated with one or more parameters of the wireless communications device,
wherein the controller is configured to use configuration data from the user profile to configure the impedance matching circuitry responsive to a determination of one or more parameters of the device associated with that configuration data.

2. Wireless communications apparatus according to claim 1 wherein the said impedance match at the circuit interface is an impedance match between a first impedance on a first side of the circuit interface and a second impedance on a second side of the circuit interface opposite the first side.

3. Wireless communications apparatus according to claim 1 wherein the impedance matching circuitry comprises tuneable impedance matching circuitry.

4. Wireless communications apparatus according to claim 3 wherein the tuneable impedance matching circuitry comprises one or more components having a tuneable impedance.

5. Wireless communications apparatus according to claim 4 wherein the one or more components having a tuneable impedance comprise a component having a reactance which varies linearly responsive to a varying control signal.

6. Wireless communications apparatus according to claim 1 wherein the controller is configured to use configuration data from the user profile to configure the impedance matching circuitry responsive to a determination of a frequency at which the antenna module is transmitting and/or receiving radio frequency signals.

7. Wireless communications apparatus according to claim 1 wherein the configuration data comprises two or more configuration data sets, each of the configuration data sets relating to a respective impedance matching configuration of the impedance matching circuitry.

8. Wireless communications apparatus according to claim 1 wherein the said parameters of the device associated with the configuration data are associated with the configuration data by way of one or more conditions.

9. Wireless communications apparatus according to claim 8 wherein each of the configuration data sets of the configuration data is associated with one or more respective conditions.

10. Wireless communications apparatus according to claim 8 wherein the controller is configured to use configuration data from the user profile to configure the impedance matching circuitry responsive to a determination that one or more conditions associated with that configuration data are or will be met.

11. Wireless communications apparatus according to claim 8 wherein the conditions associated with configuration data of the user profile comprise a sensor condition relating to one or more characteristics relating to how the user holds or wears the wireless communications device.

12. Wireless communications apparatus according to claim 8 wherein the conditions associated with the configuration data of the user profile comprise a location condition relating to a position of the wireless communications device.

13. Wireless communications apparatus according to claim 8 wherein the conditions associated with the configuration data of the user profile comprise a frequency condition relating to a frequency at which the wireless communications device is configured to transmit and/or receive communication signals.

14. Wireless communications apparatus according to claim 8 wherein the conditions associated with the configuration data of the user profile comprise one or more sensor conditions relating to signals received by the controller from the said one or more sensors of the wireless communications device.

15.-33. (canceled)

34. Wireless communications apparatus according to claim 1 wherein the wireless communications device comprises an RF front end comprising the said circuitry and the said antenna module.

35.-36. (canceled)

37. A method of adjusting an impedance match at a circuit interface of a wireless communications device comprising: circuitry in communication with an antenna module, the interface being provided within the circuitry or between the circuitry and the antenna module, the method comprising: providing impedance matching circuitry configurable to adjust an impedance match at the circuit interface; providing a user profile associated with the wireless communications device or with a user of the wireless communications device, the user profile comprising configuration data relating to one or more impedance matching configurations of the impedance matching circuitry, the configuration data being associated with one or more parameters of the wireless communications device; and using configuration data from the user profile to configure the impedance matching circuitry responsive to a determination of one or more parameters of the device associated with that configuration data.

38. Wireless communications apparatus comprising:
a wireless communications device comprising an antenna module, circuitry in communication with the antenna module, a circuit interface within the circuitry or between the circuitry and the antenna module, impedance matching circuitry configurable to adjust an impedance match at the circuit interface and an impedance mismatch sensor configured to detect an impedance mismatch at the circuit interface; and
a controller in communication with the impedance mismatch sensor, the controller being configured to determine an impedance matching configuration of the impedance matching circuitry customised for a user of the wireless communications device for reducing a detected impedance mismatch at the circuit interface by the impedance mismatch sensor,
wherein the controller is further configured to customise a user profile by storing in the user profile configuration data relating to the said determined customised impedance configuration.

39.-40. (canceled)

41. A method of customising an impedance matching scheme for a wireless communications device, the method comprising: providing a wireless communications device comprising an antenna module, circuitry in communication with the antenna module, a circuit interface within the circuitry or between the circuitry and the antenna module, impedance matching circuitry configurable to adjust an impedance match at the circuit interface and an impedance mismatch sensor configured to detect an impedance mismatch at the circuit interface, the method comprising: determining an impedance matching configuration of the impedance matching circuitry customised for a user of the wireless communications device for reducing a detected impedance mismatch at the circuit interface by the impedance mismatch sensor; and customising a user profile by storing configuration data relating to the said determined customised impedance configuration in the user profile.

42. (canceled)

43. Wireless communications apparatus comprising:
a wireless communications device comprising an antenna module, circuitry in communication with the antenna module, a circuit interface within the circuitry or between the circuitry and the antenna module and impedance matching circuitry configurable to adjust an impedance match at the circuit interface; and
a controller configured to predict a change in the impedance match at the circuit interface, or a change in one or more parameters capable of causing a change in the impedance match at the circuit interface, and to adapt an impedance matching configuration of the impedance matching circuitry in accordance with said predicted change to thereby adjust the said impedance match at the circuit interface.

44. Wireless communications apparatus according to claim 43 wherein the controller is configured to predict a change in the impedance match at the circuit interface responsive to a detected change in a position of the wireless communications device.

45. Wireless communications apparatus according to claim 43 wherein the controller is configured to monitor a position of the wireless communications device and to predict a change in the impedance match at the circuit interface responsive to a detected position of the wireless communications device.

46. Wireless communications apparatus according to claim 43 wherein the controller is configured to monitor a position of the wireless communications device and to predict a change in the impedance match at the circuit interface, or a change in one or more parameters capable of causing a change in the impedance match at the circuit interface, responsive to a determination that the wireless communications device is following a predetermined location path or that the wireless communications device is following a particular portion of a predetermined location path.

47. A method of adjusting an impedance match at a circuit interface in a wireless communications device comprising circuitry in communication with an antenna module, the circuit interface being provided within the circuitry or between the circuitry and the antenna module, the method comprising: predicting a change in an impedance match at the circuit interface, or a change in one or more parameters capable of causing a change in an impedance match at the circuit interface, and adapting an impedance matching configuration of the impedance matching circuitry in accordance with said predicted change to thereby adjust the said impedance match at the circuit interface.

48.-50. (canceled)
